(19) United States
(12) Patent Application Publication
(10) Pub. No.: US 2025/0238312 A1
(43) Pub. Date: Jul. 24, 2025

(54) MACHINE LEARNING BASED FORM ANALYSIS AND ERROR DETECTION

(71) Applicant: ADP, Inc., Roseland, NJ (US)

(72) Inventors: Yongmei Jia, Basking Ridge, NJ (US); Philip Andrew Houston, Wharton, NJ (US); Sheng Zhang, Harrison, NJ (US)

(73) Assignee: ADP, Inc., Roseland, NJ (US)

(21) Appl. No.: 19/033,270

(22) Filed: Jan. 21, 2025

Related U.S. Application Data
(60) Provisional application No. 63/623,658, filed on Jan. 22, 2024.

(51) Int. Cl. G06F 11/07

(52) U.S. Cl. CPC G06F 11/0793; G06F 11/0709; G06F 11/0766; G06F 11/079

(57) ABSTRACT

The technical solutions of the present disclosure receive, via a graphical user interface (GUI), a selection of a GUI element to view data of entity accounts generated using network operations and execute, responsive to the selection, an anomaly detection. The system can identify, responsive to the execution, from the data of the entity accounts, parameters associated with network operations execution. The system can determine, based on the data, ranges of values for the parameters, each range of values corresponding to a respective parameter. The system can detect, based on the parameters and the ranges of values input into one or more machine learning (ML) models, an anomaly corresponding to a parameter that is out of a range of values. The system can select, responsive to the detection, an action to address the anomaly and perform, responsive to the selected action, a network operation to address the anomaly.

### CROSS-REFERENCES TO RELATED APPLICATIONS

This application claims the benefit of priority under 35 U.S.C. § 119 to U.S. Provisional Patent Application No. 63/623,658, filed Jan. 22, 2024, which is hereby incorporated by reference herein in its entirety.

### TECHNICAL FIELD

This patent application generally relates to computing technology, particularly machine learning based document analysis solutions, and more particularly to technical solutions that provide machine learning based user interface responses to form queries.

### BACKGROUND

As the formats and volume of electronic forms executed by computing systems increase, it can be challenging to maintain compatibility of such forms with various processing engines without introducing excessive computing resource utilization, delays, or network latencies.

### SUMMARY

Technical solutions of this disclosure utilize machine learning (ML) to provide graphical user interface (GUI) triggered anomaly detection and correction of form data. Providing reliable anomaly detection and error correction based for various types of forms and their corresponding parameters based on GUI selections can be difficult. Network operations involving form data related to enterprises or industries such as payroll operations processing, taxation, mortgage, or healthcare computations can include anomalies that indicate errors in some parameter values. These anomalies can occur for various reasons, including inadvertent errors, as well as changes to regulations, laws or rules for filling out different forms that can occur at any time in different regions or countries, potentially impacting multi-national enterprises and their employees. Such errors can lead to erroneous network operation results, hindering user experience and wasting compute and network resources, thereby impacting the system energy efficiency.

The technical solutions of this disclosure overcome these challenges by providing GUI-based anomaly detection and correction solutions that use ML models to detect and correct anomalous data. The technical solutions can provide selectable GUI elements for viewing data involving various entity accounts and triggering anomaly detection functions. The anomaly detection functions can identify different types of form-related data parameters whose values fall outside of predetermined value ranges, thereby detecting parameter anomalies. The technical solutions then select corrective actions to adjust the parameters and perform network operations to address the anomalies, improving the user experience, system reliability and energy efficiency, while conserving the processing and network resources.

An aspect of the technical solutions is directed to a system. The system can include one or more processors, coupled with memory. The one or more processors can receive, via a graphical user interface (GUI) of a device, a selection of an element of the GUI to view data of a plurality of entity accounts generated using network operations. The one or more processors can execute, responsive to the selection and prior to performance of actions responsive to the selection, an anomaly detection function. The anomaly detection function can be executed to identify, upon the execution of the anomaly detection function, from the data of the plurality of entity accounts, a plurality of parameters associated with execution of a plurality of network operations. The one or more processors can determine, based on the data identified upon the execution of the anomaly detection function, a plurality of ranges of values for the plurality of parameters. Each range of values of the plurality of ranges can correspond to a respective parameter of the plurality of parameters. The one or more processors can detect, based on the plurality of parameters and the plurality of ranges of values input into one or more machine learning (ML) models trained using parameters and ranges of values for network operations of entity accounts, an anomaly corresponding to a parameter of the plurality of parameters that is out of a range of values of the plurality of ranges of values corresponding to the parameter. The one or more processors can select, responsive to the detection, an action to address the anomaly. The one or more processors can perform, responsive to the selected action and subsequent to the execution of the anomaly detection function, a network operation of the plurality of network operations to address the anomaly.

The one or more processors can generate a timer to expire according to a predetermined time interval. The one or more processors can provide, for display on the GUI responsive to the detection, an indication that the network operation associated with the selected action is to be performed unless a selection of a second element of the GUI to preclude the performance of the network operation is received prior to the expiration of the timer.

The one or more processors can perform the network operation in response to the expiration of the timer. The one or more processors can provide, for display via the GUI of the device, the element providing access to a graphical representation of the data of the plurality of entity accounts. The one or more processors can receive, from the device, the selection of the element in response to an interaction with the element via the GUI. The one or more processors can provide, for display via the GUI responsive to the selection, the graphical representation of the data.

The one or more processors can provide, for display on the GUI responsive to the detection, an indication of at least one of the anomaly corresponding to the parameter or the action to address the anomaly. The one or more processors can determine that the anomaly is responsive to a value of the parameter for an amount withheld from a first electronic transaction implemented via the network operation falling out of the range of values for the amount withheld. The one or more processors can adjust the value for the parameter according to the range of values for the amount withheld. The one or more processors can perform the network operation for a second electronic transaction using the adjusted value for the parameter.

The one or more processors can detect the anomaly responsive to a mismatch between a first entry of a first form associated with an entity account and a second entry of a second form associated with the entity account. Each of the first entry and the second entry can match the parameter associated with the entity account. The one or more processors can adjust, responsive to the first entry and the second entry matching the parameter, the first entry to match the second entry. The one or more processors can perform the network operation for a next electronic transaction using the adjusted first entry.

The one or more processors can detect the anomaly corresponding to the parameter of an entity account responsive to a plurality of forms from a plurality of states associated with the entity account. The one or more processors can adjust, responsive to the plurality of forms from the plurality of states associated with the entity account, a withholding amount for a next electronic transaction associated with the entity account. The one or more processors can perform the network operation for the next electronic transaction using adjusted withholding amount.

The one or more processors can receive, via the GUI, a selection of a second element to generate a report summarizing one or more detected anomalies including the anomaly and corresponding one or more actions for the detected anomalies including the action. The one or more processors can provide, for display on the GUI, the generated report.

The one or more processors can determine, based on historical data of the plurality of entity accounts, a threshold value for the range of values for the parameter. The one or more processors can generate the ranges of values of the parameter based on the threshold value. The one or more processors can receive, via the GUI, a selection of a second element to initiate a manual review of the detected anomaly. The one or more processors can provide, for display on the GUI, an interface for an input of a result for the manual review.

The one or more processors can identify one or more amounts associated with the parameter for a first form of an entity account. Each of the one or more amounts can be determined periodically over a first portion of a time interval comprising the first portion and a second portion subsequent to the first portion. The one or more processors can identify one or more withholding amounts associated with the first form. The one or more withholding amounts can be associated with the one or more amounts. The one or more processors can determine, based on a sum of the one or more amounts and a ratio between the first portion and the time interval, the range of values for a sum of withholding amounts for the time interval.

The one or more processors can identify a second one or more amounts associated with a second operation of a second form for the first portion of the time interval and a second one or more withholding amounts associated with each of the second one or more amounts. The one or more processors can generate, based at least on the second one or more amounts and the second one or more withholding amounts input into the one or more ML models, the anomaly corresponding to the parameter for a predicted withholding amount for the second portion of the time interval that is out of the range of values for the sum of withholding amounts for the time interval.

An aspect of the technical solutions is directed to a method. The method can include receiving, by one or more processors coupled with memory, via a graphical user interface (GUI) of a device, a selection of an element of the GUI to view data of a plurality of entity accounts generated using network operations. The method can include identifying, by the one or more processors responsive to execution of an anomaly detection function, from the data of the plurality of entity accounts, a plurality of parameters associated with execution of a plurality of network operations. The method can include determining, by the one or more processors based on the data, a plurality of ranges of values for the plurality of parameters. Each range of values of the plurality of ranges can correspond to a respective parameter of the plurality of parameters. The method can include detecting, by the one or more processors based on the plurality of parameters and the plurality of ranges of values input into one or more machine learning (ML) models trained using parameters and ranges of values for network operations of entity accounts, an anomaly corresponding to a parameter of the plurality of parameters that is out of a range of values of the plurality of ranges of values corresponding to the parameter. The method can include selecting, by the one or more processors responsive to the detection, an action to address the anomaly. The method can include performing, by the one or more processors responsive to the selected action, a network operation of the plurality of network operations to address the anomaly.

The method can include generating, by the one or more processors, a timer to expire according to a predetermined time interval. The method can include providing, by the one or more processors for display on the GUI responsive to the detection, an indication that the network operation associated with the selected action is to be performed unless a selection of a second element of the GUI to preclude the performance of the network operation is received prior to the expiration of the timer. The method can include performing, by the one or more processors, the network operation in response to the expiration of the timer.

The method can include providing, by the one or more processors for display via the GUI of the device, the element providing access to a graphical representation of the data of the plurality of entity accounts. The method can include receiving, by the one or more processors from the device, the selection of the element in response to an interaction with the element via the GUI. The method can include providing, by the one or more processors for display via the GUI responsive to the selection, the graphical representation of the data.

The method can include providing, by the one or more processors for display on the GUI responsive to the detection, an indication of at least one of the anomaly corresponding to the parameter or the action to address the anomaly. The method can include determining, by the one or more processors that the anomaly is responsive to a value of the parameter for an amount withheld from a first electronic transaction implemented via the network operation falling out of the range of values for the amount withheld. The method can include adjusting, by the one or more processors, the value for the parameter according to the range of values for the amount withheld. The method can include performing, by the one or more processors, the network operation for a second electronic transaction using the adjusted value for the parameter.

The method can include detecting, by the one or more processors, the anomaly responsive to a mismatch between a first entry of a first form associated with an entity account and a second entry of a second form associated with the entity account. Each of the first entry and the second entry can match the parameter associated with the entity account. The method can include adjusting, by the one or more processors, responsive to the first entry and the second entry matching the parameter, the first entry to match the second entry. The method can include performing, by the one or more processors, the network operation for a next electronic transaction using the adjusted first entry.

An aspect of the technical solutions is directed to a non-transitory computer-readable medium comprising instructions. The instructions, when executed by one or more processors coupled with memory, can cause the one or more processors to receive, via a graphical user interface (GUI) of a device, a selection of an element of the GUI to view data of a plurality of entity accounts generated using network operations. The instructions, when executed by one or more processors coupled with memory, can cause the one or more processors to execute, responsive to the selection, an anomaly detection function to identify, responsive to the execution, from the data of the plurality of entity accounts, a plurality of parameters associated with execution of a plurality of network operations. The instructions, when executed by one or more processors coupled with memory, can cause the one or more processors to determine, based on the data, a plurality of ranges of values for the plurality of parameters, each range of values of the plurality of ranges corresponding to a respective parameter of the plurality of parameters. The instructions, when executed by one or more processors coupled with memory, can cause the one or more processors to detect, based on the plurality of parameters and the plurality of ranges of values input into one or more machine learning (ML) models trained using parameters and ranges of values for network operations of entity accounts, an anomaly corresponding to a parameter of the plurality of parameters that is out of a range of values of the plurality of ranges of values corresponding to the parameter. The instructions, when executed by one or more processors coupled with memory, can cause the one or more processors to select, responsive to the detection, an action to address the anomaly. The instructions, when executed by one or more processors coupled with memory, can cause the one or more processors to perform, responsive to the selected action, a network operation of the plurality of network operations to address the anomaly.

### BRIEF DESCRIPTION OF THE DRAWINGS

Aspects of the present disclosure are described in the detailed description which follows, in reference to the noted plurality of drawings by way of non-limiting examples of exemplary embodiments of the present disclosure.

FIG. 1 illustrates an example of a system for providing an ML based form analysis and error detection.

FIG. 2 illustrates an example of a system for providing form inspection and responses to user queries relating the form using an ML model.

FIG. 3 illustrates an example form for analysis by an ML model.

FIG. 4 can illustrate an example prompt and a corresponding data structure (e.g., a JSON object) generated for the form.

FIG. 5 illustrates an example communication exchange between a client device and the data processing system concerning the form and receiving responses from an ML model.

FIG. 6A illustrates an example of communication exchange between the client device and the data processing system, via the user interface, on inconsistencies or errors in the form.

FIG. 6B illustrates an example of communication exchange between the GUI of the client device and the data processing system providing responses with respect to the form.

FIGS. 7A and 7B illustrate examples of communication exchanges generated and responded to by the ML models.

FIGS. 8A-10B, illustrate examples of systems using application-based user interface for searching data and responding to user queries using ML models.

FIG. 11A illustrates an example system for training or retraining the ML model of the technical solutions.

FIG. 11B illustrates an example of a flow diagram of operations implemented by an anomaly detection function during the course of detecting anomalies.

FIG. 11C illustrates examples configuration of input and output data structures that can be used for implementing anomaly detection involving personal information verification.

FIG. 11D illustrates an example configuration of an operation or action performed by an anomaly detection function.

FIGS. 11E-11G illustrate examples of prompts used as inputs to ML models to direct the ML models to implement information data matching and comparison.

FIG. 11H illustrates an example flow diagram of method for identifying anomalies involving tax withholding amounts.

FIG. 11I illustrates an example flow diagram of a method for identifying anomalies involving tax withholding amounts when an additional source of income is involved.

FIG. 11J illustrates an example flow diagram of a method for identifying anomalies involving multi-state tax relationships.

FIG. 12 illustrates a block diagram of a computing system for implementing the embodiments of the technical solutions, in accordance with embodiments.

FIG. 13 illustrates a flow diagram of a method for providing an ML based form analysis and error detection, including GUI triggered anomaly detection and correction of form data.

### DETAILED DESCRIPTION

The technical solutions provide a graphical user interface (GUI) based anomaly detection and error correction of form data. Providing GUI-based anomaly detection and error correction for various types of forms and their corresponding parameters can be a challenge. Performing network operations on various form data concerning enterprises or industries involved in payroll processing, taxation, mortgage, or healthcare operations can include anomalies indicative of errors in some of the parameter values associated with particular forms. Enterprises can struggle with network operations involving erroneous electronic network data, which can be caused by unexpected form-related regulation changes across different regions or jurisdictions, resulting in overutilization of processing and network resource and inefficient energy consumption.

The technical solutions described herein overcome these challenges by providing a GUI-based anomaly detection and correction solutions that utilize ML models to detect take corrective actions on anomalous data. The technical solutions can provide selectable GUI elements for viewing data and triggering anomaly detection functions. The technical solutions can utilize the anomaly detection to identify form-related data parameters whose values fall outside of predetermined value ranges established for such parameters and detect anomalies. The technical solutions can select corrective actions to adjust the parameters and perform network operations addressing the anomaly.

The solutions can apply ML functionalities, including trained generative artificial intelligence models, to provide automated review and error detection of data corresponding to various forms filled-out in the course of business operations. The forms reviewed for error correction can include any enterprise, business, or payroll forms, such as, a U.S. federal tax Form W-2, Wage and Tax Statement, Form W-3, Transmittal of Wage and Tax Statements or Form W-4, Employee's Withholding Certificate. While the example forms listed here are U.S.-based, the technical solutions described herein are not limited to U.S.-based forms, and can be applicable with forms from other countries. Further, the technical solutions described herein are not limited to federal/national level forms and apply to forms that may be from local governing bodies, such as state, county, city, municipality, or any other such jurisdiction. Further yet, the technical solutions described herein are not applicable only to government/public forms, but are also applicable to forms that may be provided by business organizations, non-profit organizations, unions, individuals, or any other entities.

The technical solutions can utilize ML models, for example, to identify potential discrepancies concerning form-related payroll operations, such as computations of specific values in the form entries. For example, a discrepancy may exist in a total annual income, annual taxable income, amount of tax deductions, or any other entries of an electronic form, where such entries are used in computations can be used for the completion of a payroll process. For instance, consider a tax form (e.g., W-2 form in the U.S.). A user can provide a series of inputs to populate the electronic tax form, and also user-generated questions related to the tax form and/or the process in which the tax form may be used. The receiving system can transmit the inputs, and questions to a ML model. The ML model can be trained to analyze and inspect the tax form for accuracy and identify any errors or potential discrepancies with any of the form entries (e.g., accuracy of the computed or entered values).

The technical solutions can include a generative artificial intelligence model-based tax form anomaly detection functionality for reviewing data of various forms associated with entity accounts of different clients or their employees to identify and correct anomalies. By leveraging ML model capabilities, the technical solutions can allow for administration personnel to utilize graphical user interface (GUI) dashboard to view data of multiple entity accounts, triggering an anomaly detection function. The anomaly detection function can identify, from the data on values of parameters associated with form entries of different entity accounts, anomalous parameters that are outside of their expected range of values. The technical solutions can then select and take actions, such as initiating network operations to update or adjust the anomalous parameters to conform to the range of values. The technical solutions can perform network operations to address the anomalies, such as by performing the network operations using the adjusted parameters.

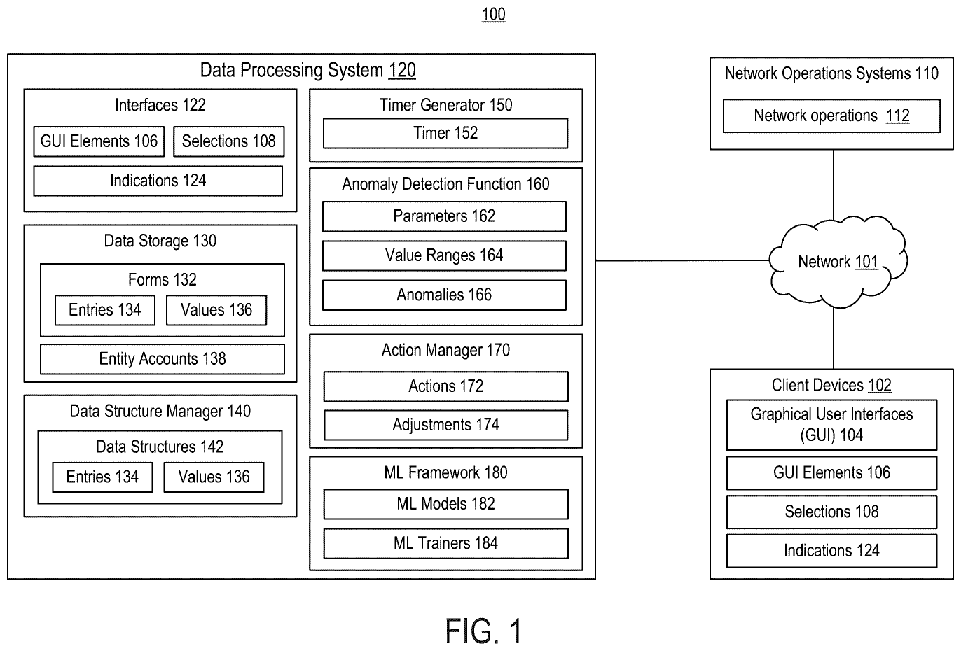

FIG. 1 illustrates an example system 100 for providing GUI-based anomaly detection and error correction of form data. Example system 100 can include one or more data processing systems 120 communicatively coupled with one or more client devices 102 and network operations systems 110, via one or more networks 101. A client device 102 can include one or more graphical user interfaces (GUIs) 104 for displaying GUI elements 106 and receiving selections 108 of such GUI elements 106 to be provided to the data processing system 120 for initiating anomaly detection. The GUI 104 can receive from the interface 122 of the data processing system 120 and display various indications 124 (e.g., concerning actions 172 taken to address various anomalies 166). A network operations system 110 can include, provide or execute one or more network operations 112, such as operations for computing various parameters pertaining to employee or enterprise tax computations that for various forms 132.

A data processing system 120 can include, execute, use or provide one or more of: interfaces 122, data storages 130, data structure managers 140, timer generators 150, anomaly detection functions 160, action managers 170 and machine learning (ML) frameworks 180. An interface 122 of the data processing system 120 can communicate with a GUI 104 of the client device 102 (e.g., receive or transmit) GUI elements 106 and selections 108 of such GUI elements 106 by the users at the client device 102. The interface 122 can receive, transmit, identify or process various data of different forms 132 including different entries 134 and their corresponding values 136 that are associated with parameters 162 and provide indications 124 to the client device 102 for display via the GUI 104. The interface 122 A machine learning framework 180 of the data processing system 120 can generate, manage, provide or operate one or more ML models 182 and ML trainers 184 for training the ML models 182 to be utilized by any of the data structure manager 140, timer generator 150, anomaly detection function 160, or an action manager 170 for performing their functionalities or operations. A data storage 130 can include databases or other storage functionalities for storing and providing access to forms 132 of various entity accounts 138 (e.g., electronic accounts of enterprises and their employees). The forms 132 can include various entity account data, including entries 134 and their corresponding values 136 associated with different parameters 162 being monitored by the anomaly detection function 160.

A data structure manager 140 of the data processing system 120 can generate, manage, process or identify one or more data structures 142, such as a JavaScript Object Notation (JSON) objects, representing or identifying the entries 134 and values 136 of various forms 132 as they are processed by the anomaly detection function 160. A timer generator 150 of the data processing system 120 can generate and manage one or more timers 152 to be provided as GUI elements 106 for selection by users at the GUI 104 to trigger actions 172 or network operations 112. An anomaly detection function 160 of the data processing system can identify various data (e.g., forms 132 represented as data structures 142) of various entity accounts 138 to monitor various parameters 162 in connection with respective value ranges 164 and identify any anomalies 166 (e.g., anomalous parameters 162 falling out of their respective value range 164). Action manager 170 can select, initiate, execute and manage various actions 172 to make the adjustments 174 by correcting the anomalies 166 (e.g., anomalous parameters 162). The action manager 170 can initiate, trigger or execute network operations 112 in the course of implementing actions 172 and in order to address the detected anomalies 166.

Client devices 102 can include any combination of hardware and software for interacting with data processing system 120 using a GUI 104 of the client device 102. Client devices 102 can include computers, smartphones, tablets, or any other electronic devices capable of running applications and connecting via networks 101. Client devices 102 can include one or more GUIs 104 for displaying GUI elements 106 and receiving selections 108 by users of such GUI elements 106. For example, a client device 102 can included a workstation computer, a tablet or a smartphone operated by a user to execute an application to display a GUI 104. The GUI 104 can provide the user with GUI elements 106 that can include visual representations of operations or actions that a user can take or visual representation of data, such as data of forms 132 associated with various entity accounts 138. Client devices 102 can be an administrator operating station allowing a user with administrator level access to review and analyze data (e.g., entries 134 and values 136 associated with parameters 162) of one or more entity accounts 138.

Graphical user interfaces (GUIs) 104 can include any combination of hardware and software for facilitating user interaction with client devices 102. A graphical user interface 104 can include any type of interfaces, including command-line interfaces (CLIs), or voice-activated interfaces. GUIs 104 can receive GUI elements 106 from interface 122 of a data processing system 120 which can allow for user interaction (e.g., clicking or touch screen selection). The GUI 104 can detect interactions with a portion of a display of a GUI representation and thereby detect a selection 108 of a user. The GUI 104 can process the selection 108 and transmit it, or an indication, message or response that a selection tool place, to the interface 122 of the data processing system 120. For example, a GUI on a computer can allow a user to input a selection 108 of a GUI element 106 corresponding to an option to open, access, view or preview data (e.g., forms 132) of a plurality of entity accounts 138 associated with one or more entities (e.g., enterprises, corporations or organizations). The GUI 104 can receive indications 124 associated with various anomalies 166 identified with respect to any parameters 162 associated with different values or entries of forms 132, as well as any actions 172 taken to make adjustments 174.

Network operations systems 110 can include any combination of hardware and software for managing payroll-related operations or processes. Network operations systems 110 can include computations of the values 136 corresponding to specific parameters 162 for specific entries 134 of forms 132. Network operations systems 110 can execute one or more network operations 112, such as processing operations for computing or determining employee or enterprise tax amounts (e.g., values 136) associated with particular parameters 162, such as those concerning salary calculations, benefits or retirement contribution amounts, overtime payment amounts, deductions management, direct deposit processing, payroll reporting, compliance with tax regulations, year-end tax form generation, and employee time tracking. For example, a network operations system 110 can calculate the total annual income and tax deductions for an employee based on the entries 134 in a Form W-2. Network operations systems 110 can communicate with the data processing system 120 to execute network operations 112 to take actions 172 using or implementing adjustments 174 (e.g., adjusted parameters 162 that were identified as anomalous prior to adjustments).

Network operations 112 can include any combination of operations and computations related to payroll management. Network operations 112 can involve any combinations of processes, circuitries, devices or computer code for providing computations or calculations of various entries 134 of forms 132 associated with any parameters 162. Network operations 112 can include processing operations for calculating employee salary amounts, taxable income amounts, tax withholding amounts, tax deductions, retirement account deduction amounts, payment processing amounts or any other payroll or tax related operations. Network operations 112 can include processes, circuitries, computer codes or devices for performing computations of employee salaries, bonuses and issuing physical or electronic payments of such computation amounts. Network operations 112 can include, for example, employee tax computations, salary calculations, benefits administration, overtime calculations, deductions management, direct deposit processing, payroll reporting, compliance with tax regulations, year-end tax form generation, and employee time tracking. Network operations 112 can include, for example, calculating total annual income, determining federal tax withheld, computing state tax withheld, calculating Social Security wages, determining Medicare wages, computing additional Medicare tax, calculating dependent care benefits, determining retirement plan contributions, and generating year-end summaries for W-2, W-3, W-4, or other similar tax forms. Network operations 112 can be executed by network operations systems 110 and can utilize data from various forms 132. For example, a network operation 112 can compute the amount of tax withheld based on the entries 134 in a Form W-4. The network operations 112 can generate data that can be used by the data processing system 120 to validate user and provide accurate responses 172.

Data processing system 120 can include any combination of hardware and software for providing GUI-based anomaly detection and error correction of form data. Data processing system 120 can be deployed on a central server or across a distributed computing environment, such as one or more physical or virtual machines, or on a cloud-based system. The data processing system 120 can include, execute, or provide one or more interfaces 122 that can be communicatively coupled with and can operate together with GUI 104 of the client device. The data processing system 120 can include, execute or provide data structure managers 140, timer generators 150, anomaly detection functions 160, action managers 170, and ML frameworks 180. The data processing system 120 can receive selections 108 of GUI elements 106 from client devices 102 and trigger anomaly detection function 160 to identify and address any anomalies 166 of different parameters 162. For example, the data processing system 120 can include an anomaly detection function 160 to use ML models 182 to identify or detect anomalies 166 corresponding to parameters 162 that are out of their corresponding value range 164.

Interfaces 122 can include any combination of hardware and software for facilitating communication between different components of the system 100. An interfaces 122 can include any type of an interference, such as a CLI or a communication interface to operate together or in conjunction with the GUI 104 of the client devices 102. The interface 122 can generate, trigger, instruct for, initiate or provide GUI elements 106 to be displayed on the GUI 104 of the client device 102. Interface 122 can receive selections 108 or indications of selections 108 from the client device 102, and in response initiate or trigger the anomaly detection function 160. The interface 122 can issue and provide for display at the client device 102, one or more indications 124, including indications of a timer 152 in response to whose expiration an action 172 is to be taken or executed. Interfaces 122 can facilitate seamless communication and data exchange within the system 100, including with network operations systems 110 and any of the network operations 112 that can be triggered, activated or utilized by the data processing system 120.

GUI elements 106 can include any combination of visual components to be displayed on a graphical user interface (GUI) 104 for user interaction. GUI elements 106 can include buttons, icons, menus, and other interactive components that allow users to navigate and interact with the system. For example, GUI elements 106 can provide access to data of entity accounts 138 and trigger anomaly detection function 160. The GUI elements 106 can display indications 124 related to actions taken to address anomalies 166. For instance, a graphical component, such as an image or a button on the GUI 104 can be selected to view data of a plurality of entity accounts 138 generated using network operations 112. The GUI elements 106 can also include visual representations of data, such as charts or graphs, to help users understand the information. GUI elements 106 can include or provide notifications or alerts, such as indications 124, to inform users of detected anomalies 166 and the actions 172 taken, or to be taken, to address such anomalies 166.

Selections 108 can include any user inputs or interactions with the GUI elements 106. Selections 108 can be made using various input devices, such as a mouse, keyboard, or touch screen. For example, selections 108 can include clicking a button to view data of entity accounts 138 or selecting an option to execute an anomaly detection function 160. The selections 108 can trigger specific actions within the system, such as initiating a network operation or generating a report. For instance, a user can select a GUI element 106 to view a graphical representation of data, which can help in identifying anomalies 166. The selections 108 can also include inputs for adjusting parameters 162 or values 136 associated with the parameters 162 within forms 132 within the system. For instance, a selection 108 can provide a setting for a timer 152 for a network operation. Selection 108 can include an input by a user of the GUI 104, such as textual input in the form of a query to request information about an issue or component. Selections 108 can be used to navigate through different sections of the GUI 104, providing a seamless user experience.

Indications 124 can include any visual or auditory notifications provided by the system to inform users of specific events or actions. Indications 124 can be displayed on the GUI 104 or provided through other means, such as texts or messages to other communication systems. Indications 124 can notify users of detected anomalies 166 in the data of entity accounts. The indications 124 can also inform users of the actions 172 taken to address these anomalies, such as implementation of adjustments 174 made to parameters 162 or their corresponding values. For instance, an indication 124 can be displayed on the GUI 104 to show that a network operation 112 is being performed to address an anomaly 166. The indications 124 can also include alerts for upcoming events, such as a timer 152 that is set to expire at a predetermined time, and if no action is taken by the user prior to the expiration of the timer 152, the system will automatically implement the recommended action 172. Indications 124 can provide summaries of detected anomalies 166 and the corresponding actions 172 taken, helping users stay informed about the system's status.

Data storage 130 can include any combination of hardware and software for storing and managing data within the system. Data storage 130 can be used to store data of entity accounts 138, forms 132, parameters 162, ML model training datasets and other relevant information. Data storage 130 can include a database 202 and can include any functionality of the database 202, and vice versa. Data storage 130 can include databases or other storage functionalities for storing forms 132 of various entity accounts 138. The data storage 130 can provide access to this data for other components of the system, such as the anomaly detection function 160. For instance, data storage 130 can store historical data used to determine threshold values for parameters. The data storage 130 can also include backup and recovery mechanisms to ensure data integrity and availability. Data storage 130 can support data encryption and other security measures to protect sensitive information.

Forms 132 can include any electronic documents that can be generated, referenced or used by the data processing system 120, client device 102 or network operations system 110. The forms 132 can include any forms any network operation 112, such as payroll, taxation, benefits enrollment, direct deposit authorization, time-off requests, expense reports, employee evaluations, compliance certifications, onboarding documents, termination forms, loan applications, insurance claims, purchase orders, service requests and vendor agreements or scheduling. Forms 132 can have various entries 134 that can be populated by different values 136, which can include any string of characters for filling up a form 132. For example, a Form W-2 can include entries 134 for employee name, annual income, and tax withheld and values 136 can include the characters (e.g., letters or numbers) used to fill out such entries 134. Forms 132 can be processed by the data processing system 120 to facilitate anomaly detection and error correction in response to selections 108 of GUI elements 106 at a GUI 104 of a client device 102.

Entries 134 can include any individual data fields within forms 132. Entries 134 can be populated by different values 136 and can correspond to specific data points corresponding to various parameters 162. For example, an entry 134 in a payroll form can include a value 136 corresponding to an amount of employee's annual income. The employee's annual income can be a parameter 162 of one or more operations 112 for computing various payroll or tax related operations involving this parameter. Entries 134 can be identified and processed by the data processing system 120 and can be analyzed for anomaly detections by the anomaly detection function 160. Entries of forms 132 The data processing system 120 can use ML models 182 to identify any anomalies 166 in the entries 134 and take corresponding corrective actions 172.

Values 136 can include any characters that can be used to populate entries 134 in forms 132. The values 136 can include characters that are numerical, textual, symbolic (e.g., symbols) or of any other format relevant to the form 132. For example, a value 136 in a tax form entry 134 can be the amount of tax withheld. Values 136 can be processed by the data processing system 120, such as by utilizing one or more automated network operations systems 110 to implement specific network operations 112 to identify anomalies 166 among various parameters 162. The data processing system 120 can use data structures 142 to process the values 136 associated with the parameters 162, improving the data reliability.

Entity accounts 138 can include any electronic accounts associated with entities, such as enterprises, organizations, or individuals (e.g., employees employed by the enterprises or organizations). Entity accounts 138 can organize or store data related to various forms 132, parameters 162, and network operations 112. For example, entity accounts 138 can include electronic accounts of enterprises and their employees, storing data such as payroll information, tax forms, and other relevant documents. The data processing system 120 can use this data to perform anomaly detection and other functions. For instance, entity accounts 138 can include data of forms 132, which can be analyzed to identify anomalies 166. The entity accounts 138 can also store historical data used to determine threshold values of the value ranges 164 for parameters 162. Entity accounts 138 can be used to generate reports summarizing detected anomalies and the corresponding actions taken.

Data structure manager 140 can include any combination of hardware and software for generating, processing, utilizing and managing data structures 142. The data structures 142 can include or indicate various entries 134 and values 136 of the corresponding forms 132. The data structure manager 140 can utilize ML models 182 configured (e.g., trained or prompted) to generate data structures 142 along with the specific entries 134 or values 136. For example, a data structure manager 140 can create a data structure 142 that is a JSON object representing various entries 134 and values 136 of a payroll form 132. These data structures 142 can be used by other components of the data processing system 120, such as an anomaly detection function 160 to identify anomalies 166 among parameters 162 based on value ranges 164.

Data structures 142 can include any organized formats for storing and managing data. These structures 142 can represent entries 134 and values 136 of forms 132. For example, a data structure 142 can be a JSON object that includes the entries 134 and values 136 of a tax form. Other than JSON objects, the data structures 142 can utilize or include XML (extensible Markup Language), YAML (YAML Ain't Markup Language), BSON (Binary JSON), MessagePack, Protocol Buffers (Protobuf), Avro, Thrift, CSV (Comma-Separated Values), Parquet, and ORC (Optimized Row Columnar). Data structures 142 can be generated by the data structure manager 140 and used by other components of the data processing system 120.

Timer generator 150 can include any combination of hardware and software for generating and managing timers 152 within the system 100. Timer generator 150 can generate timers 152 for various implementations, including to automate an implementation of an action 172 (e.g., execution of a network operation 112) in response to absence of any user interaction with a GUI element 106 comprising a timer 152 displayed on the GUI 104 of the client device 102. The timers 152 can be used to trigger specific actions or events based on predetermined time intervals. Timer generator 150 can generate a timer 152 to expire according to a predetermined time interval, triggering a network operation 112 to address an anomaly 166. The timer generator 150 can provide these timers as GUI elements 106 for selection by users. For instance, a user can set a timer to initiate a network operation 112 after a specific period. The timer generator 150 can also manage multiple timers simultaneously, ensuring that each timer expires at the correct time. Timer generator 150 can provide indications 124 (e.g., notifications or alerts) when a timer 152 is about to expire, helping users stay informed about upcoming events.

Timer 152 can include any combination of hardware and software for tracking, counting or managing a time interval. Timer 152 can be used to trigger specific actions 172 or events based on predetermined time interval expiration. For example, timer 152 can be generated by the timer generator 150 and set to expire according to a predetermined time interval. The expiration of the timer 152 can trigger an action 172 that can be implemented by utilizing one or more network operations 112 to address an anomaly 166. For instance, a timer 152 can be set to initiate a network operation after a specific period, ensuring that the operation is performed at the correct time. The timer 152 can also be used to provide notifications or alerts when it is about to expire, helping users stay informed about upcoming events. Timer 152 can be managed and adjusted by users through the GUI, allowing for scheduling actions and events.

Anomaly detection function 160 can include any combination of hardware and software for identifying and addressing anomalies within the system. This function can use machine learning (ML) models to detect and correct anomalous data. For example, the anomaly detection function 160 can initiate, trigger or execute the anomaly detection function 160, responsive to a selection 108 of a GUI element 106 made at the GUI 104 of the client device 102 and prior to performance of actions 172 responsive to this selection. The anomaly detection function 160 can identify, upon the triggering, initiation or execution of the anomaly detection function, from the data of the plurality of entity accounts 138, a plurality of parameters 162 (e.g., corresponding to values 136 of entries 134 of forms 132) that are associated with execution of a plurality of network operations 112. The anomaly detection function 160 can determine, based on the data identified upon the execution of the anomaly detection function 160, a plurality of ranges of values (e.g., 164) for the plurality of parameters 162. Each range of values of the value ranges 164 can correspond to, or be configured or made for, a respective parameter 162 of the plurality of parameters.

The anomaly detection function 160 can identify data parameters whose values fall outside of predetermined value ranges 164, thereby detecting anomalies. The anomaly detection function 160 can then select corrective actions to adjust the parameters 162 and perform network operations 112 to address the anomalies 166. For instance, the anomaly detection function 160 can detect an anomaly 166 based on a mismatch between entries 134 of forms 132 associated with an entity account. The function can then adjust the entries 134 to match each other, ensuring data consistency. The anomaly detection function 160 can generate reports summarizing detected anomalies and the corresponding actions taken, helping users stay informed about the system's status.

Anomaly detection function 160 can also include capabilities for identifying anomalies based on historical data and trends. For example, the anomaly detection function 160 can use historical data of entity accounts 138 to determine threshold values (e.g., bounds) for various parameters 162. These threshold values can be used to establish value ranges 164 for monitoring current data. If a parameter 162 value falls outside of these value ranges 164, the anomaly detection function 160 can detect an anomaly 166 and select an appropriate corrective action (e.g., by triggering via API calls one or more network operations 112). For instance, if the historical data indicates that the average tax withholding amount for a particular entity account is within a specific range, any deviation from this range can trigger an anomaly detection. The anomaly detection function 160 can then adjust the withholding amount to bring it back within the acceptable range, ensuring compliance with tax regulations and preventing errors in payroll processing.

The anomaly detection function 160 can identify anomalies based on multi-state data and regulatory changes. For example, the function can detect discrepancies in forms 132 associated with entity accounts 138 that operate in multiple states. These discrepancies can arise due to differences in state regulations, tax laws, or reporting requirements. The anomaly detection function 160 can analyze the data from multiple states and identify any inconsistencies or mismatches. For instance, if an entity account 138 includes forms 132 from different states with conflicting tax withholding amounts, the anomaly detection function 160 can detect this as an anomaly 166. The function can then select corrective actions 172 to reconcile the discrepancies, such as adjusting the withholding amounts to comply with the regulations of each state. This ensures that the entity accounts remain compliant with all applicable laws and regulations.

The anomaly detection function 160 can generate detailed reports summarizing detected anomalies and the corresponding actions taken. These reports can be provided as indications 124 and can include valuable insights into the system's performance and help users stay informed about the status of their data. For example, the anomaly detection function 160 can generate a report that lists all detected anomalies 166, the parameters 162 involved, the value ranges 164, and the corrective actions taken. The report (e.g., indication 124) can also include graphical representations of the data, such as charts or graphs, to help users visualize the anomalies and understand their impact. The generated reports can be customized to include specific details relevant to the user's needs, such as the frequency of anomalies, the types of corrective actions taken, and the overall effectiveness of the anomaly detection function 160.

Parameters 162 can include any data points or values associated with the execution of network operations 112 within the system 100. Parameters 162 can be used to monitor and analyze various aspects of the system's performance. For example, parameters 162 can include values related to payroll processing, taxation, and other network operations. The anomaly detection function 160 can use these parameters to identify anomalies and take corrective actions. For instance, parameters 162 can include values for tax withholding amounts, which can be monitored to detect anomalies. The parameters 162 can also be used to determine value ranges 164 for various data points, helping to identify when values fall outside of expected ranges.

Value ranges 164 can include any predetermined ranges of values associated a parameter 162 within the system 100. Value ranges 164 can be used to monitor and analyze data points, helping to identify anomalies 166. Value ranges 164 can be determined based on historical data of entity accounts 138, providing thresholds for various parameters 162. The anomaly detection function 160 can use the value ranges 164 to detect when data points (e.g., parameters 162 associated with particular entries 134 of forms 132) fall outside of expected ranges. For instance, value ranges 164 can be used to monitor tax withholding amounts, ensuring that tax withholding values for a given income bracket remain within acceptable range for that particular income bracket. The value ranges 164 can be adjusted based on detected anomalies, helping to maintain data accuracy and consistency. The value ranges 164 can be used to generate reports summarizing detected anomalies and the corresponding actions 172 taken.

Anomalies 166 can include data points (e.g., parameters 162) that are not equal to expected values or that fall outside of expected value ranges 164 for the given parameter type. Anomalies 166 can indicate errors or inconsistencies in the data, triggering corrective actions 172. For example, anomalies 166 can be detected based on a mismatch between entries of forms associated with an entity account 138. The anomaly detection function 160 can identify the anomalies 166 and select actions 172 corresponding to such anomalies to address these specific anomalies 166. For instance, anomalies 166 can include values for tax withholding amounts that fall outside of predetermined value ranges. The anomaly detection function 160 can adjust the values 136 of this parameter 162 to address the tax withholding amount so as to bring the year-end amount of tax withholding within the desired value range 164, thereby ensuring data accuracy and consistency. Anomalies 166 can be used to generate reports summarizing detected anomalies and the corresponding actions taken, helping users stay informed about the system's status.

Action manager 170 can include any combination of hardware and software for selecting, initiating, and managing actions 172. Actions 172 can be used to address detected anomalies 166 and ensure data accuracy and consistency. The action manager 170 can perform one or more network operation 112 of the plurality of network operations 112 provided by a network operations system 110 in order to address a detected anomaly 166 with respect to a parameter 162. For instance, the action manager can perform an operation 112 to address an anomaly 166 of a parameter 162 responsive to a selected action 172 and subsequent to the execution of the anomaly detection function 160 (e.g., in response to a user interaction with a GUI element 106 triggering a selection 108 at the GUI 104).

Action manager 170 can select actions to adjust parameters 162 based on detected anomalies 166. The action manager 170 can initiate network operations 112 to perform, compute or determine the adjustments 174 for the anomalous parameters 162. For instance, action manager 170 can select an action to adjust tax withholding amounts based on detected anomalies 166, thereby producing an adjustment 174 which can include a value to either correct the parameter 162 or to replace parameter 162. The action manager 170 can also manage multiple actions simultaneously, ensuring that each action is performed at the correct time. Action manager 170 can provide notifications or alerts to inform users of the actions taken and their outcomes.

Actions 172 can include any operations or tasks performed to address or correct detected anomalies 166. Actions 172 can be selected and initiated by the action manager 170 and can include any one or more network operations 112 selected or triggered to make adjustments 174 to replace parameters 162 that are identified as anomalous (e.g., outside of the value range 164). Actions 172 can include operations for adjusting parameters based on detected anomalies. The actions 172 can be performed by executing network operations 112 implemented using network operations system 110. For instance, actions 172 can include adjusting tax withholding amounts based on detected anomalies 166. For example, in response to determining that a parameter 162 for a tax withholding amount is outside of its value range 164, action manager 170 can trigger one or more network operations 112 to make an adjustment 174 to bring the tax withholding amounts within the expected range. The actions 172 can include generating reports summarizing detected anomalies and the corresponding actions taken. Actions 172 can be managed and adjusted by users through the GUI, providing flexibility in addressing anomalies and maintaining data accuracy.

Adjustments 174 can include any changes or modifications made to parameters or values within the system to address detected anomalies 166. Adjustments 174 can be selected and initiated by the action manager 170. For example, adjustments 174 can include changing tax withholding amounts based on detected anomalies. The adjustments 174 can be implemented by executing network operations 112, applying the changes to the anomalous parameters 162 (e.g., replacing anomalies 166 with adjustments 174). For instance, adjustments 174 can include modifying values for payroll processing parameters to ensure data accuracy and consistency. The adjustments 174 can also be used to update value ranges for various parameters, helping to maintain data accuracy and consistency. Adjustments 174 can be managed and adjusted by users through the GUI 104, providing flexibility in addressing anomalies 166 and maintaining data accuracy.

ML frameworks 180 can include any combination of hardware and software for implementing any ML or artificial intelligence (AI) functionalities. The ML framework 180 can manage and provide ML trainers 184 for training ML models 182 and can provide, deploy and retrain ML models 182 to perform functionalities on behalf of any data processing system 120 component (e.g., data structure manager 140, timer generator 150, anomaly detection function 160 and action manager 170). For example, an ML framework 180 can train an ML model 182 to detect anomalies 166 and take corrective actions 172 using, or according to, adjustments 174 on behalf of an anomaly detection function 160 or action manager 170.

ML models 182 can include any trained ML or AI algorithms used by the data processing system 120. ML models 182 can configured (e.g., trained or prompted) for any combination of data processing, data validation, identification of anomalies 166 or selection of actions 172 to make corrections. The ML models 182 can be trained using parameters 162, value ranges 164, anomalies 166 and form entries 134. For example, an ML model 182 can be trained to detect anomalies 166 in tax form entries 134 and select appropriate actions 172 to be triggered or used to correct the anomalies.

The ML models 182 can include any combination of one or more neural networks, decision-making models, linear regression models, natural language models, random forests, classification models, generative AI models, reinforcement learning models, clustering models, neighbor models, decision trees, probabilistic models, classifier models, or other such models. For example, the models 182 include natural language processing (e.g., support vector machine (SVM), Bag of Words, Counter Vector, Word2Vec, k-nearest neighbors (KNN) classification, long short term memory (LSTM)), object detection and image identification models (e.g., mask region-based convolutional neural network (R-CNN), CNN, single shot detector (SSD), deep learning CNN with Modified National Institute of Standards and Technology (MNIST), RNN based long short term memory (LSTM), Hidden Markov Models, You Only Look Once (YOLO), LayoutLM) (classification ad clustering models (e.g., random forest, XGBBoost, k-means clustering, DBScan, isolation forests, segmented regression, sum of subsets 0/1 Knapsack, Backtracking, Time series, transferable contextual bandit) or other models such as named entity recognition, term frequency-inverse document frequency (TF-IDF), stochastic gradient descent, Naïve Bayes Classifier, cosine similarity, multi-layer perceptron, sentence transformer, data parser, conditional random field model, Bidirectional Encoder Representations from Transformers (BERT), among others.

The ML models 182 can include generative AI models, also referred to as generative AI models 182, which can include any machine learning systems configured to create new content, such as text, images, or audio, by learning patterns from the data stored in the database 202 (e.g., training datasets). The generative AI models 182 can be trained using techniques, such as supervised learning, unsupervised learning, and reinforcement learning. Generative AI models 182 can utilize data set from the stored data to create logical inferences between various complex structures in the data set to generate coherent outputs for prompts input into the models 182.

The ML models 182 implemented as generative AI models can include any machine learning (ML) or artificial intelligence (AI) model designed to generate content or new content, such as text, images, or code, by learning patterns and structures from existing data. Such generative AI model 182 can be any model, a computational system or an algorithm that can learn patterns from data (e.g., chunks of data from various input documents, computer code, templates, forms, etc.) and make predictions or perform tasks without being explicitly programmed to perform such tasks. The generative AI model 182 can refer to or include a large language model. The generative AI model 182 can be trained using a dataset of documents (e.g., text, images, videos, audio or other data). The generative AI model 182 can be designed to understand and extract relevant information from the dataset. The generative AI model 182 can leverage natural language processing techniques and pattern recognition to comprehend the context and intent of the prompt (e.g., instruction), which can be used as input into the ML model 182.

The generative AI model 182 can be built using deep learning techniques, such as neural networks, and can be trained on large amounts of data. The generative AI model 182 can be designed, constructed or include a transformer architecture with one or more of a self-attention mechanism (e.g., allowing the model to weigh the importance of different words or tokens in a sentence when encoding a word at a particular position), positional encoding, encoder and decoder (multiple layers containing multi-head self-attention mechanisms and feedforward neural networks). For example, each layer in the encoder and decoder can include a fully connected feed-forward network, applied independently to each position. The data processing system 120 can apply layer normalization to the output of the attention and feed-forward sub-layers to stabilize and improve the speed with which the generative AI model 182 is trained. The data processing system 120 can leverage any residual connections to facilitate preserving gradients during backpropagation, thereby aiding in the training of the deep networks. Transformer architecture can include, for example, a generative pre-trained transformer, a bidirectional encoder representations from transformers, transformer-XL (e.g., using recurrence to capture longer-term dependencies beyond a fixed-length context window), text-to-text transfer transformer,

The generative AI model 182 can be trained (e.g., by a model training function) using any text-based dataset by converting the text data from the input dataset documents into numerical representations (e.g., embeddings) of the chunks of those documents. For example, the dataset can include various tax forms such as Form W-2, Form W-3, and Form W-4, which contain entries related to employee income, tax withholdings, and other payroll-related data. The model can be trained to understand the specific terminology and structure of these tax forms to accurately identify anomalies and correct errors. These embeddings can capture the semantic meaning of words, paragraphs, pages or sentences, depending on the size and type of chunks of dataset documents are parsed into. Embeddings can be used to represent and organize the dataset documents within a high-dimensional space (e.g., embedding space), where similar documents or concepts are located closer together. Embedding space can include a multi-dimensional vector space where each data point is represented by an embedding.

ML trainers 184 can include any combination of hardware and software for training ML models 182. These trainers 184 can use datasets forms 132 for various entity accounts 138 along with various parameters 162 and their corresponding value ranges 164 to train the models 182. For example, the datasets can include various tax forms such as Form W-2, Form W-3, and Form W-4, which include entries related to employee income, tax withholdings, and other payroll-related data. These trainers 184 can train ML models 182 using datasets comprising various parameters 162 across different entity accounts 138 to identify and form value ranges 165 for given types of parameters 162 based on types of entity accounts 138 identify different types of anomalies 166. For example, an ML trainer 184 can train an ML model 182 to detect anomalies 166 in payroll form entries 134 across different entity accounts 138 and select correct actions 172 to provide adjustments 174 by utilizing relevant network operations 112. ML trainers 184 can be managed by ML frameworks 180 and utilized by the data processing system 120 to enhance its operations. These trainers 184 can retrain the ML models 182 using updated data from the database 202 of the example system 200 to ensure that ML models 182 remain accurate and effective.

Through training, a generative ML model 182, also referred to as a generative AI model 182, or adjust its understanding of mapping the embeddings to particular issues (e.g., prompts related to resource availability or constraints concerning the resources), by adjusting its internal parameters. For example, the model can be trained using datasets comprising various tax forms such as Form W-2, Form W-3, and Form W-4, which contain entries related to employee income, tax withholdings, and other payroll-related data. Internal parameters can include numerical values of a generative AI model that the model learns and adjusts during training to optimize its performance and make more accurate predictions. Such training and can include iteratively presenting the various data chunks or documents of the dataset (e.g., or their chunks, embeddings) to the generative AI model 182, comparing its predictions with the known correct answers, and updating the model's parameters to minimize the prediction errors. By learning from the embeddings of the dataset data chunks, the generative AI model 182 can gain the ability to generalize its knowledge and make accurate predictions or provide relevant insights when presented with prompts.

The generative AI model 182 can include any ML or AI model or a system that can learn from a dataset to generate new content (e.g., text or images) that resembles a distribution of the training dataset. A distribution of a dataset can include an underlying probability distribution representing the patterns and characteristics of the data used to train a generative AI model 182. For example, a training data distribution can represent statistical properties of a text data (e.g., text corpus), such as the frequency of words, the co-occurrence of terms, and the overall structure of the language used in the training dataset. The generative AI model 182 can include the functionality to utilize such a probability distribution of patterns and characteristics to generate new responses (e.g., predictions) that were not present in the dataset. For example, the generative AI model 182 can be trained on a dataset of tax forms, such as Form W-2, Form W-3, and Form W-4, to identify anomalies 166 for specific parameters 166 associated with entries 134 of forms 132 that are related to payroll or tax processing, such as pay-period post-tax payment amounts, pay-period tax withholdings, and other payroll-related operations or data.

The network 101 can be a wireless or wired connection for connecting and allowing the data processing system 120 with other components of system 100. The network can include a hardwired connection (e.g., copper wire or fiber optics) or a wireless connection (e.g., wide area network (WAN), controller area network (CAN), local area network (LAN), or personal area network (PAN)). The network 101 can include Wi-Fi, Bluetooth, BLE, or other communication protocols for transferring over networks as described herein. The network can include the Internet, intranet or any combination of wired and wireless links and connections allowing data communication.

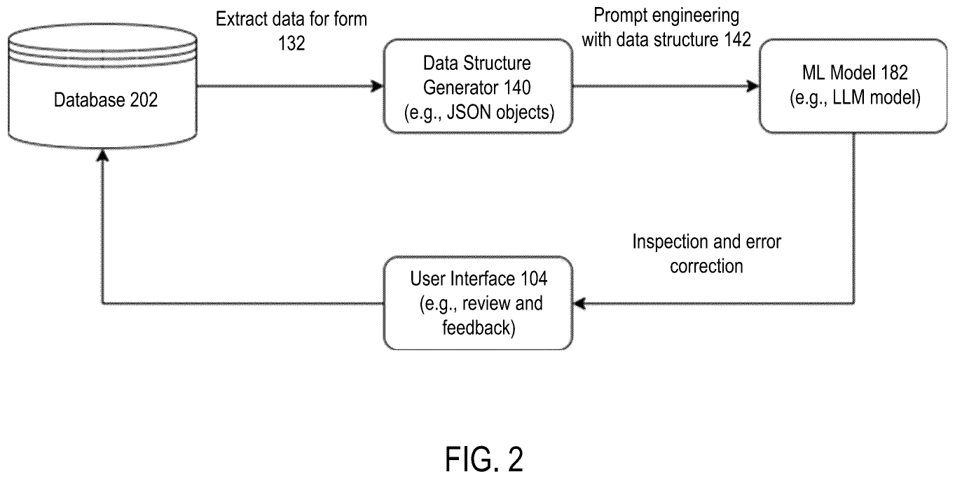

FIG. 2 illustrates an example of a system 200 for providing anomaly detection and error correction in the context of providing user query responses (e.g., answers to user questions) using an ML models 182. The system 200 can be utilized within or along with the example system 100 of FIG. 1. System 100 can include a database 202, which can comprise, be contained within or used with, a data storage 130 for storing data (e.g., tax form information), as well as a data structure manager 140 for generating JSON objects, an ML model 182 (e.g., a generative artificial intelligence model, a large language model (LLM) model or a transformer neural network model) and a graphical user interface 104 for providing review and feedback. An LLM can typically refer to an ML or AI model trained on a vast amount of text data, often comprising billions of parameters, which allows it to understand and generate human-like text with high accuracy. In contrast, medium or small language models are trained on smaller datasets and have fewer parameters, typically ranging from millions to tens or hundreds of millions, resulting in less accurate and less comprehensive text generation capabilities. System 200 can be a system for providing ML model-based tax inspection to help clients and their employees detect and correct errors in their tax forms. System 200 can be used to identify anomalies 166 and correct or prevent errors in the tax forms 132 from being delivered to clients and their employees. System 200 can be used to help clients and their employees answer specific tax-related questions based on their W-2 forms.

Database 202 can store any type of data, which can be accessed or utilized by any component of the data processing system 120, including ML trainer 184 and data structure manager 140. Database 202 can store various employee or enterprise data that can be used for populating or generating any type of forms, such as payroll, tax, business, government or human resources forms. For example, the data of the database 202 can include information found within the W-2 form and other similar tax forms, including a wide array of data points, such as personal employee data, including employee's name, address, and social security number and/or employer data, such as employer's identification number (EIN). The data stored in the database 202 can include financial information, including employee's total wages, tips, and other types of compensation, as well as federal income tax amount withheld, social security wages and the corresponding tax deductions, as well as equivalent figures for Medicare wages and taxes withheld. State-specific data can include state income tax withholdings to particulars related to state wages, tips, and more. The stored data can include insights into local income tax withholdings, corresponding local wages and tips, and noteworthy adjustments to income. The data can include contributions to plans such as 401(k), alongside benefits tied to dependent care and other categories. The forms may involve alphanumeric codes paired with specific monetary values, pertinent to various items like health insurance premiums and nonqualified plans, among other relevant components.

The data stored in the database 202 can be accessed, used or incorporated by the ML model within an ML trainer 184 for training and testing of the ML models 182, as well as for prompt information, or any other functionality of the data processing system 120. For instance, the stored data encompasses or identifies elements like the project model's purpose, scope, anticipated outcomes, and potential impacts. The data can delve into performance metrics and evaluation criteria, outlining anticipated output ranges or values for specific form fields, such as salary brackets or withheld taxes. For instance, the data can correspond to ethical, legal, and regulatory considerations related to ML model usage are covered, along with risk evaluation and mitigation strategies. The roles and responsibilities of stakeholders throughout development, deployment, and upkeep can be specified in the data, alongside documentation standards, communication practices, quality assurance procedures, and validation protocols. The model's feedback mechanisms and performance monitoring strategies can be addressed using the data stored in the database 202.

System 200 can include and incorporate real-world data and feedback to improve the accuracy and reliability of the ML models 182 via iterated process. For instance, once utilized by the data processing system 120, the forms, entries, values, queries and responses can each be stored in the data that can be used for iterative and updated training of ML models 182 to improve their performance with continued use. For example, ML models 182 can be fine-tuned by the ML trainers 184 for specific tax domains and scenarios (e.g., specific tax brackets, types of employee positions, industries, salary ranges and other information).

System 200 can be coupled with or include a graphical user interface 104 that is a graphical user interface (GUI) that can allow the user to communicate with the ML model 182 (e.g., an LLM) so as to receive selections 108 of various GUI elements 106 to trigger anomaly detection function 160, identify anomalies 166 and take actions 172 to provide adjustments 174 and indications 124 to provide back to the GUI 104. The GUI 104 can include or operate along with an application allowing the user of the client device 102 to enter inputs (e.g., selections 108), which can be converted by the system into formats readable by the data processing system components, such as the ML model 182.

The graphical user interface 104 (e.g., the GUI 104) can include a search bar for the user to search journey pages, contents and for users (e.g., employees) to ask questions about payroll, tax, and other aspects of tax preparation. The search bar can allow the users to search database information. Database 202 can include and store numerous (e.g., tens of thousands or hundreds of thousands) of documents on taxes, such as any help and support articles, compliance, poster, policies. Search engine can help clients find the correct content accurately and efficiently.

For example, system 200 can include features and functions for searching data, such as search and intelligence services powered by natural language processing (NLP) or other ML functionalities to provide search capabilities for applications and websites. For example, system 200 can include third party search functions leveraging ML-based intelligent search services powered by NLP and ML functionalities.

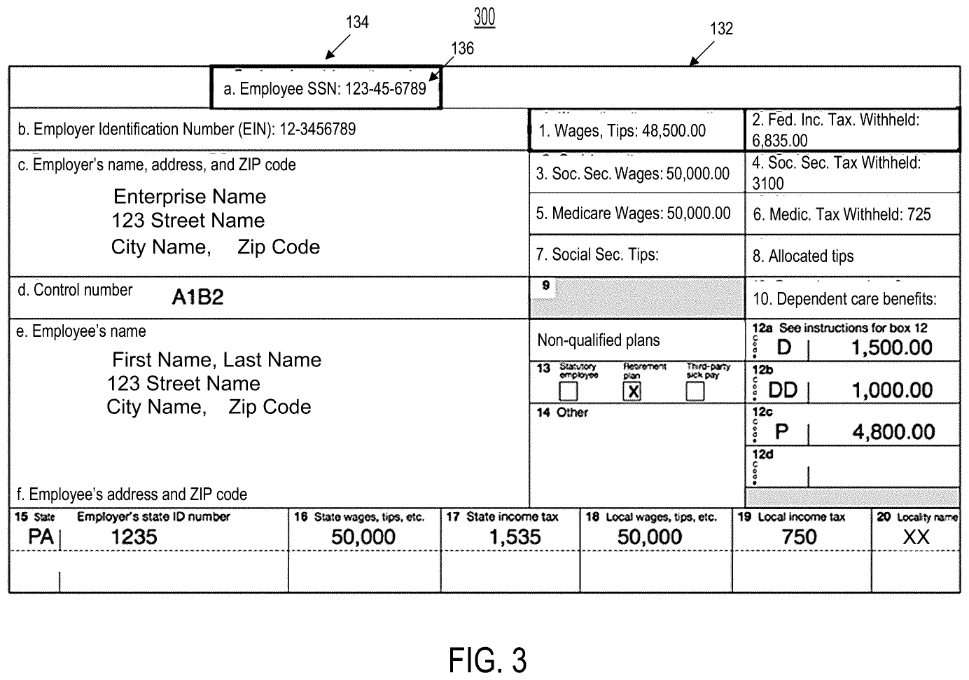

FIG. 3 illustrates an example form 132 having entries 134 containing values 136, which can be provided for analysis by the data processing system 120 and its ML models 182. The form 132 can include any type of form of a form, such as a tax form (e.g., a W-2 or an IRS 1040 form) filled out for a particular employee of a company or a tax form for an enterprise (e.g., a corporation or a business). The form 132 can include a loan application form (e.g., a mortgage application or a personal loan), an immigration form (e.g., visa application or a green card application), a healthcare form (e.g., insurance claim, or a medical history form), an application for attending an academic institution (e.g., a college admission form, financial aid form), a job application (e.g., resume, employment history), a legal form (e.g., a contract, a power of attorney, a rental lease form), a government benefits form (e.g., social security forms or unemployment forms), a vendor registration form (e.g., a supplier information, biding form, financial transactions forms), real estate form (e.g., purchase and sales agreement) or any other type and form of a form.

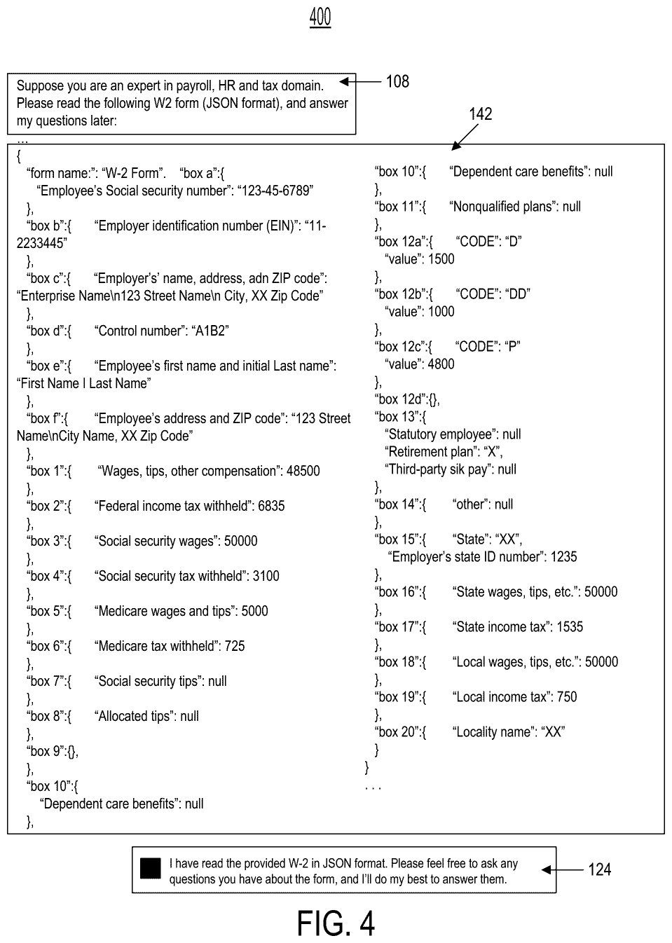

Example form 132 can include various entries 134, such as entries “a.” through “e.” corresponding to employee's social security number, employer identification number, employer's name and address, control number and employee's name and address. These entries 134 can each include their own values 136 providing characters (e.g., letters, numbers and symbols) providing specifics about each of the entries 134. The form 132 can be provided, for analysis and inspection, to the ML model trained on a data set of a particular type of form, such as for example, tax forms and tax related data, as illustrated in FIG. 3. In the instances in which other types of forms (e.g., for different fields, such as healthcare, legal form or a loan application form), the ML model can be trained on the dataset for that respective particular field (e.g., healthcare dataset in the case of healthcare form analysis, legal dataset in the case of legal form analysis, loan dataset in the case of loan form analysis or any other types of datasets for any types of forms). To utilize an ML model, a prompt function can be utilized. For example, a prompt function can receive a tax form and convert it to a prompt. The prompt can include a data structure. Data structure can include one or more JSON objects, such as an object illustrated in FIG. 4.

FIG. 4 can illustrate an example of a data structure 142, such as an example JSON object, generated for a form 132 of FIG. 3 (e.g., a JSON data structure for a tax form). Data structure 142 (e.g., JSON object) can be generated and presented along with a user query entry from a client device 102 (e.g., entry acting as a user input selection 108) which can be used for input into the ML model 182. Data structure 142 can include any number of entries for any number of inputs for the form (e.g., values, character strings or other entries). For example, a JSON object can identify an employer and an employee by name and address. The address can include the street address, the zip code, the city name and the state. The form can include an entry identifying the employee's social security number, employee's amount of wages, tips and other compensation, social security wages, Medicare wages and tips, amount of federal income tax withheld, social security tax withheld and Medicare tax withheld. Example form 132 and the corresponding JSON object 142 can include or identify employer's state ID number, state wages, state income tax, local wages, tips, local income tax as well as other entries and selections.

The example form 132 and/or data structure 142 (e.g., JSON object) can include one or more anomalies 166, such as typographical errors, inconsistencies or mistakes input in the entries of the form 132. For example, in the first line of JSON object: “form name: ”: “W-2 Form” can include an addition (e.g., repetitive) colon inside the quote. For example, in the box “c”, “Employer's′ name, address, adn ZIP code”, there can be a typo “adn” which corresponds to the word “and”. For example, in the box 13: ““Third-party sik pay”, a typo “sik” can be included, which should correspond to “sick”. In the box 5: “5000”, a typo as to the amount “5000” can be directed to “50000”. The data processing system 120 can propose actions 172 to make adjustments 174 to the anomalies 166, fixing the values 136 of the form 132, and any related typos or format-related issues. An explanation for the query response can be provided as a GUI element 106 or an indication 124 to the client device 102.

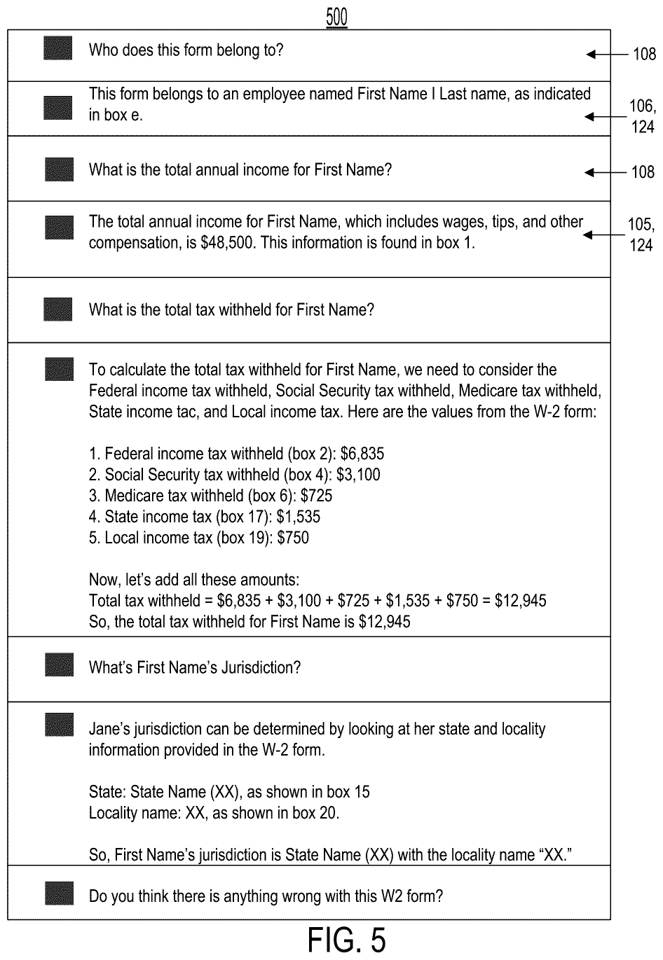

FIG. 5 illustrates an example 500 of exchanges of user queries (e.g., selections 108) from a client device 102 and GUI elements 106 or indications 124 from a data processing system 120 utilizing the ML models 182 provided to the GUI 104. In example 500, the client device 102 can provide various selections 108 (e.g., user inputs or queries comprising questions about operations) including details of a tax form 132 via a graphical user interface (GUI) 104. The data processing system 120 can utilize one or more ML models 182 to provide one or more responsive GUI elements 106 or indications 124, in response to the selections 108. For instance, example 500 can facilitate the user to ask the ML model 182 questions on employee name on the W-2 form, the annual income for the employee, the total tax withheld and the jurisdiction for this employee.

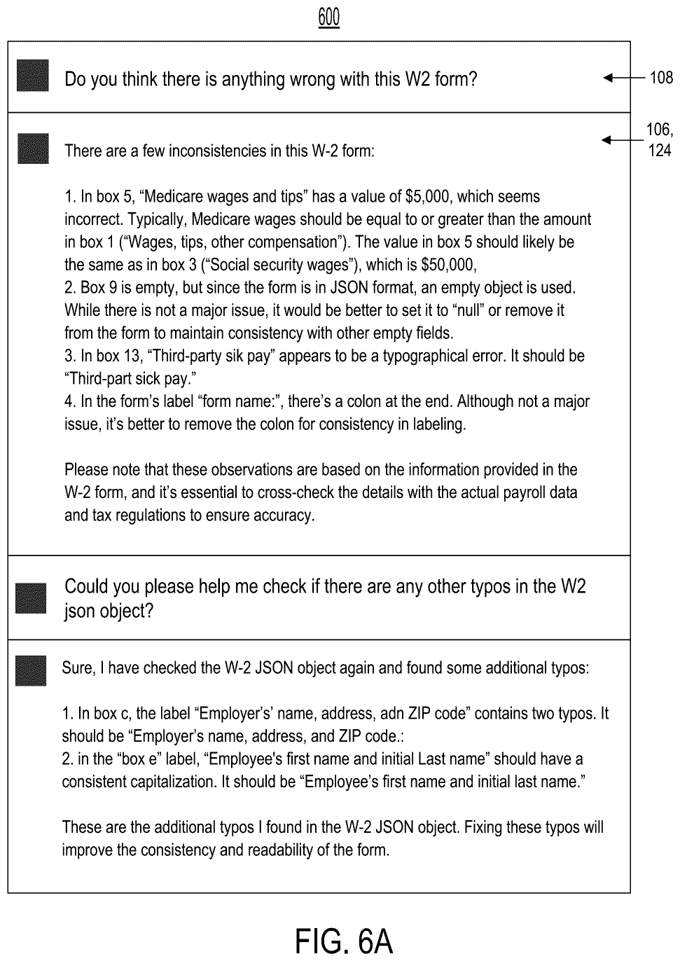

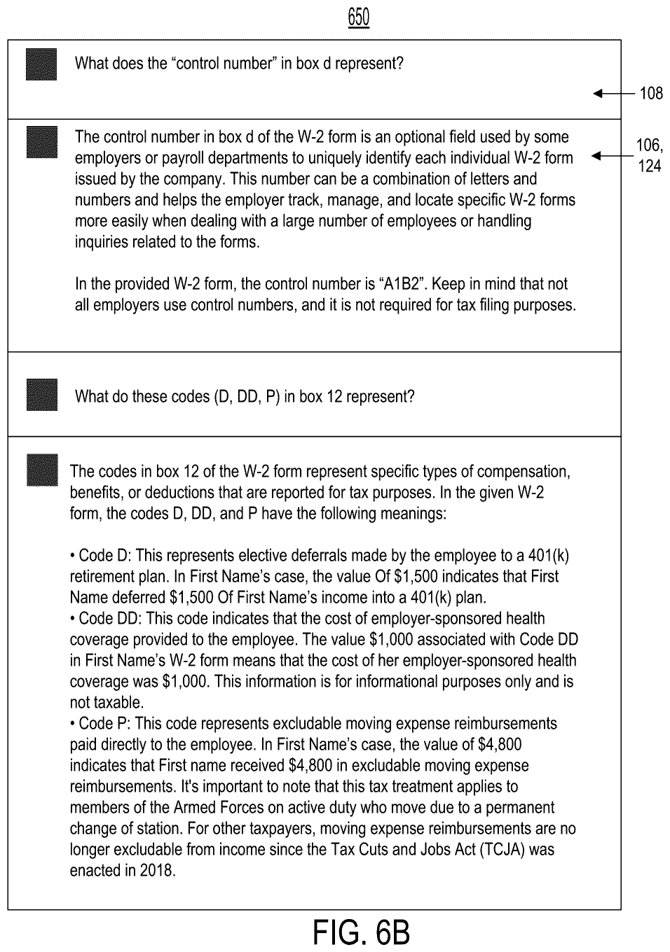

FIG. 6A illustrates an example of communication exchange 600 including user queries provided as selections 108 and GUI elements 106 and indications 124 provided to the client device 102. For example, communication exchange 600 can include questions or prompts about any errors (e.g., typos) in the tax form. The ML model 182 can provide answers to the user questions, which can be provided to the user via the GUI. For example, in response to a question about any inconsistencies, ML model can identify the typo in box 5, due to the large amount of training data used to train the AI model and the prompt message instruction triggering the ML model to identify the typos and inconsistencies. As a result, responsive to the prompts, the AI model can behave like a real tax expert to tell users why the ML model believed the value “$5000” in box 5 seemed wrong.

FIG. 6B illustrates an example of communication exchange 650 of user queries provided as selections 108 and GUI elements 106 or indications 124 provided as responses to queries. The user can, via selections 108, request explanations on particular portions of the form 132 and ML model can provide responses or explanations via indications 124, explaining the requested portions of the form. For example, communication exchange 650 can include a user query on the specific meaning of some codes and terminology, e.g., the meaning of “control number” for box d, the meaning of codes “D”, “DD” and “P” for the particular box in the code.

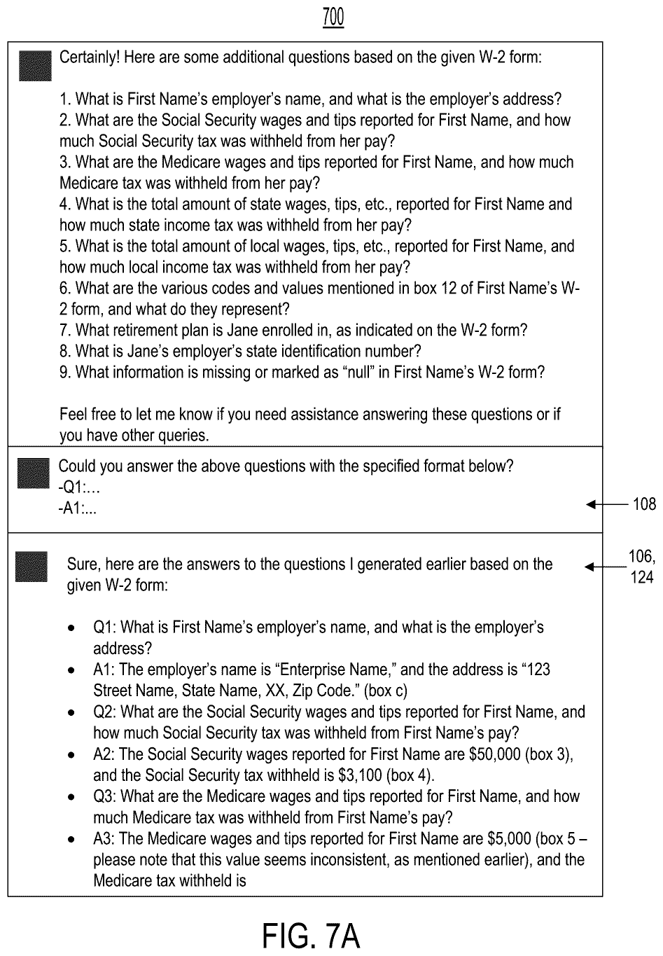

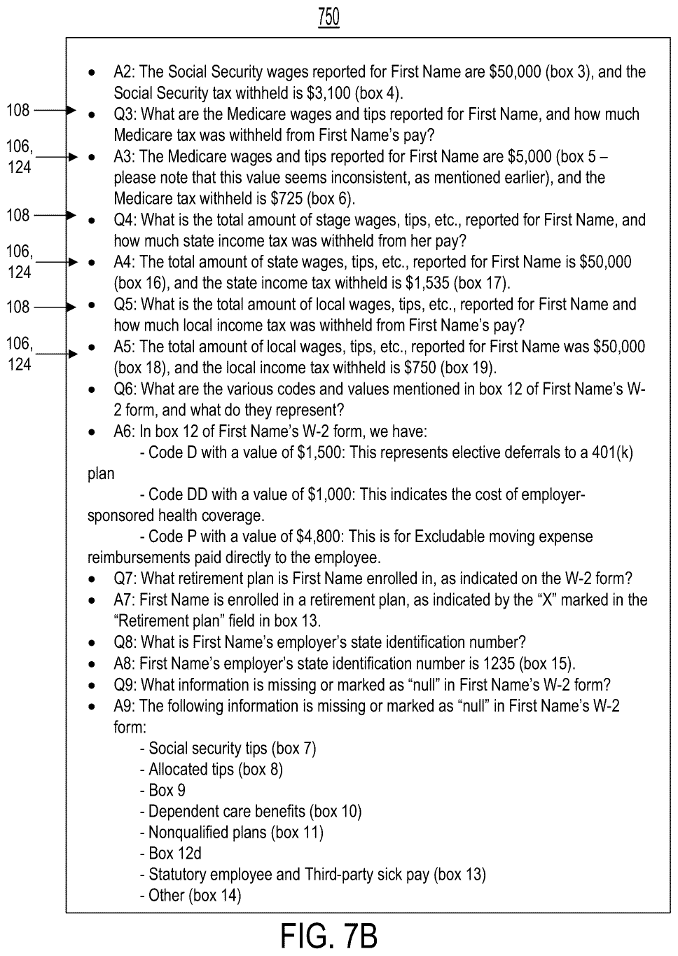

FIGS. 7A-7B illustrate examples of communication exchanges 700 and 750 of user queries provided as selections 108 from a client device 102 and GUI elements 106 and indications 124 provided as responses to the user queries provided via ML model. For example, a user can ask the ML model to generate some questions based on the given W-2 form and answer them with the required format. The ML model can provide a list of questions and answer the questions in a particular format.

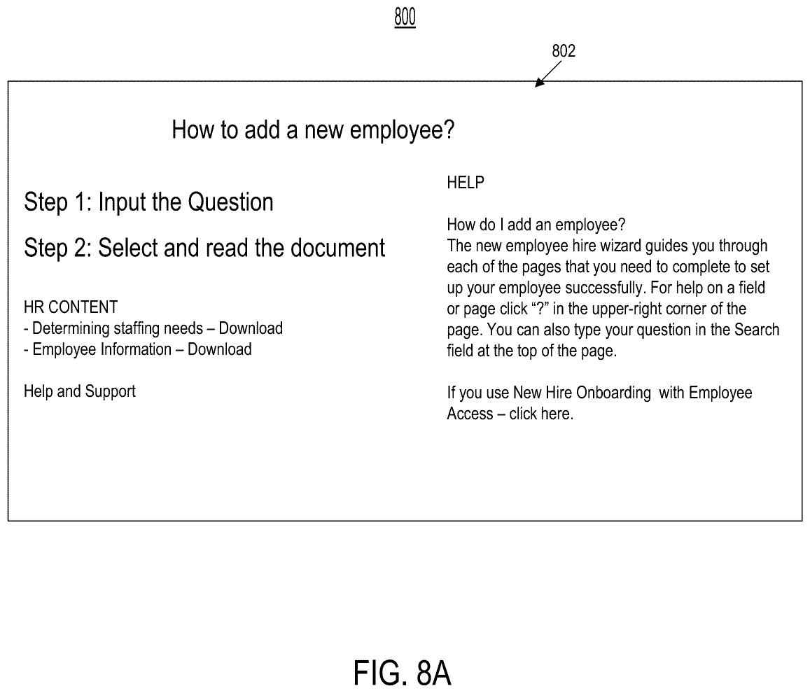

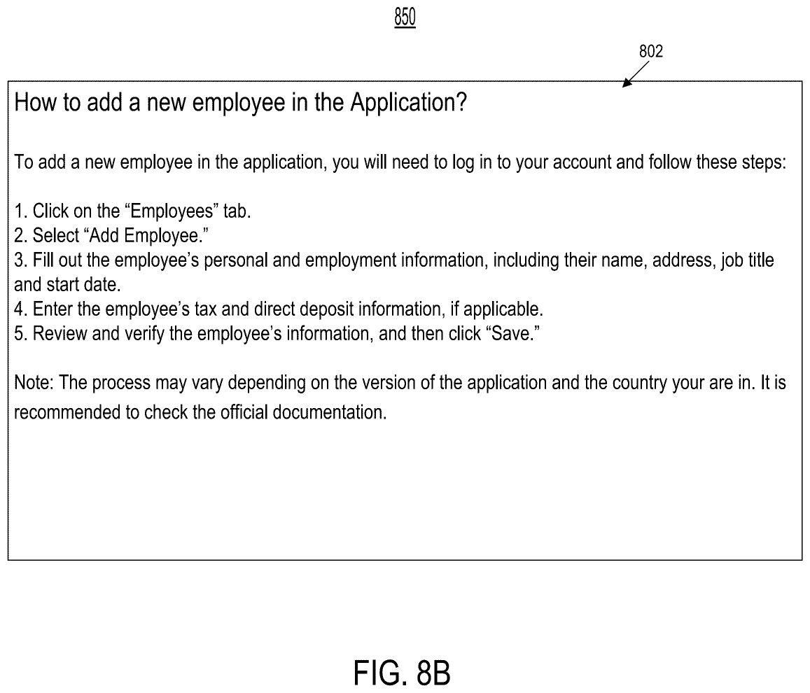

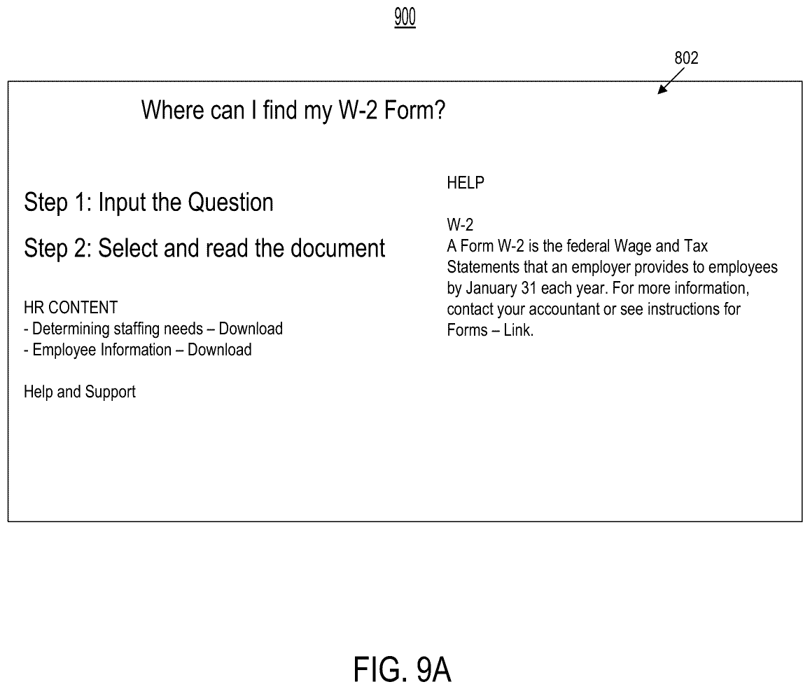

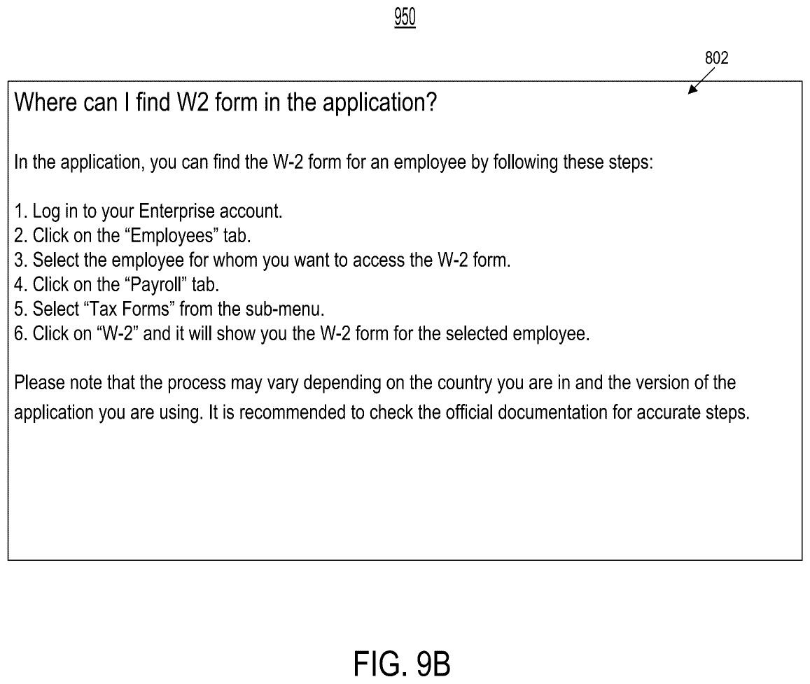

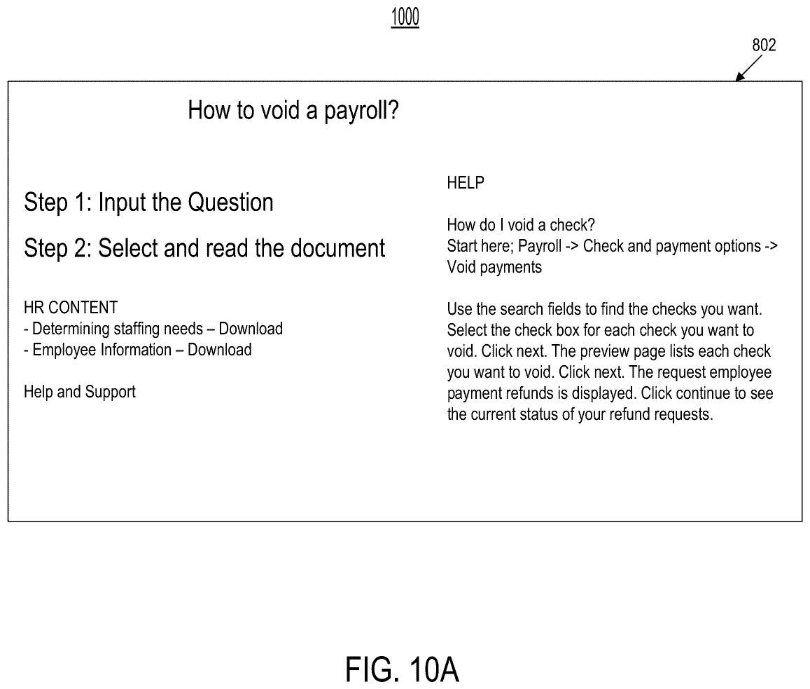

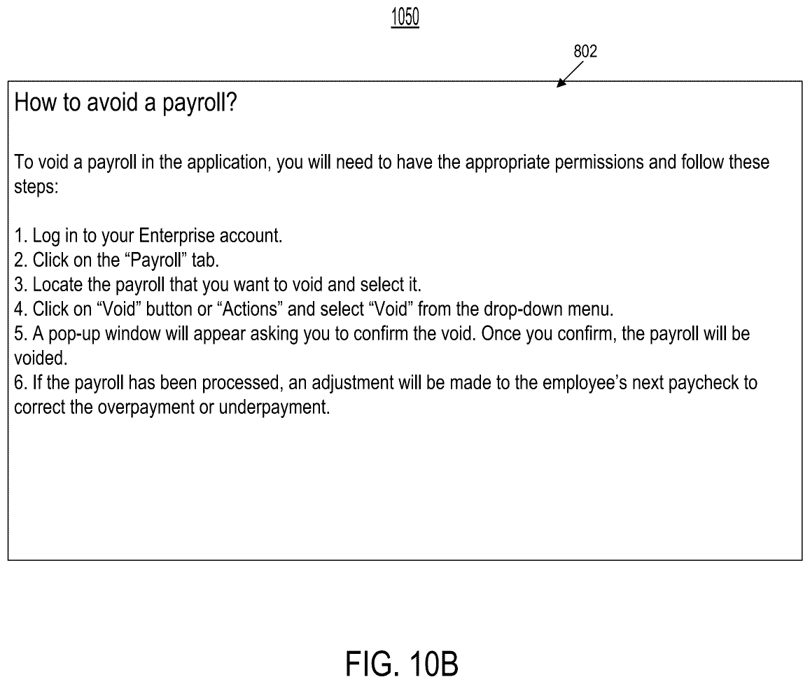

FIGS. 8A-10B illustrate examples of screenshots 800, 850, 900, 950, 1000 and 1050 of windows 802 utilizing application interface for searching data using ML. FIGS. 8A and 8B illustrate example screenshots 800 and 850 of windows 802 for graphical user interface 104 for searching for directions to add a new employee to a system. FIGS. 9A-9B illustrate example screenshots 900 and 950 of windows 802 for searching for directions to find an employee's own tax form (e.g., W2) on the system. FIGS. 10A-10B illustrate example screenshots 1000 and 1050 of windows 802 for searching for directions to find a way to void a payroll.

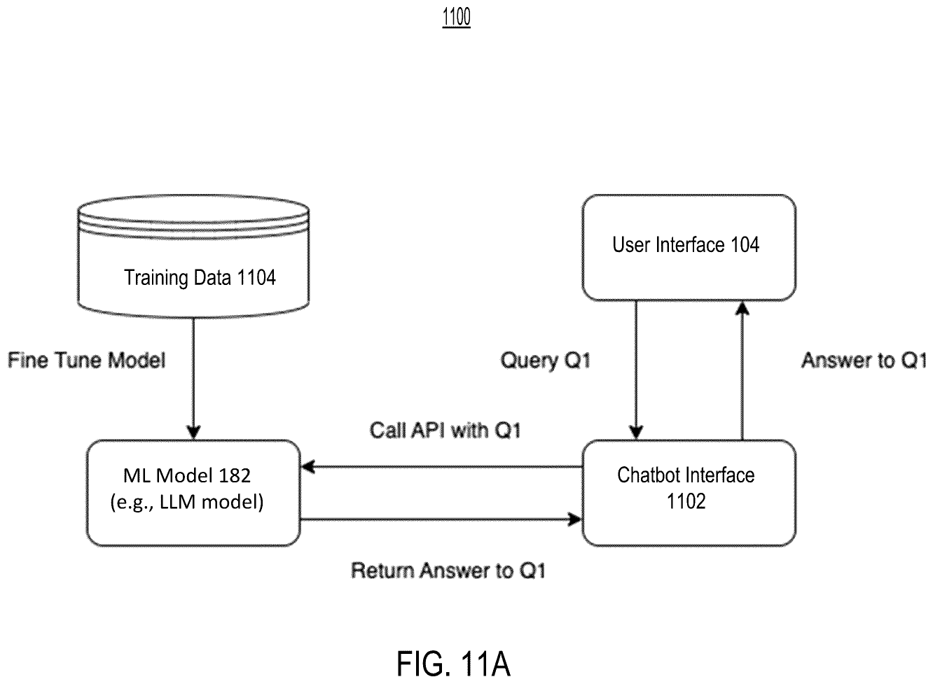

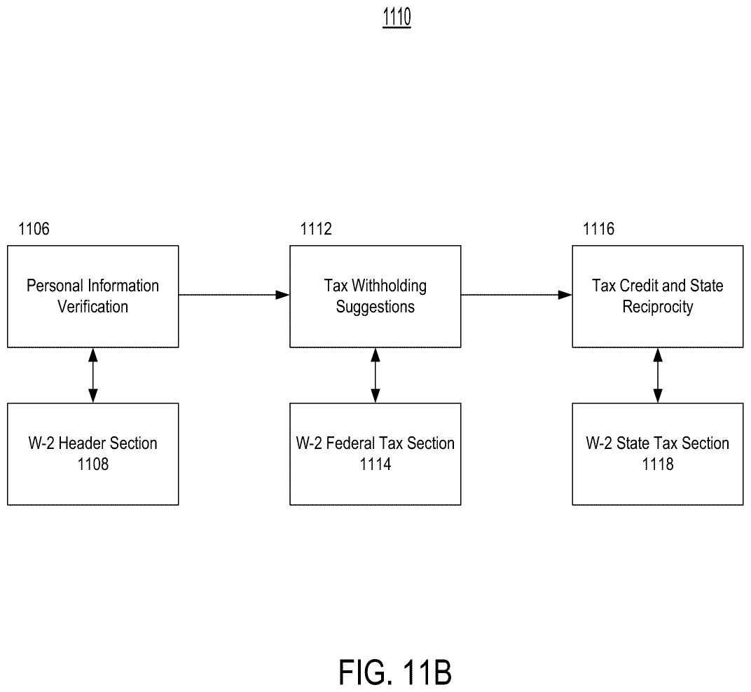

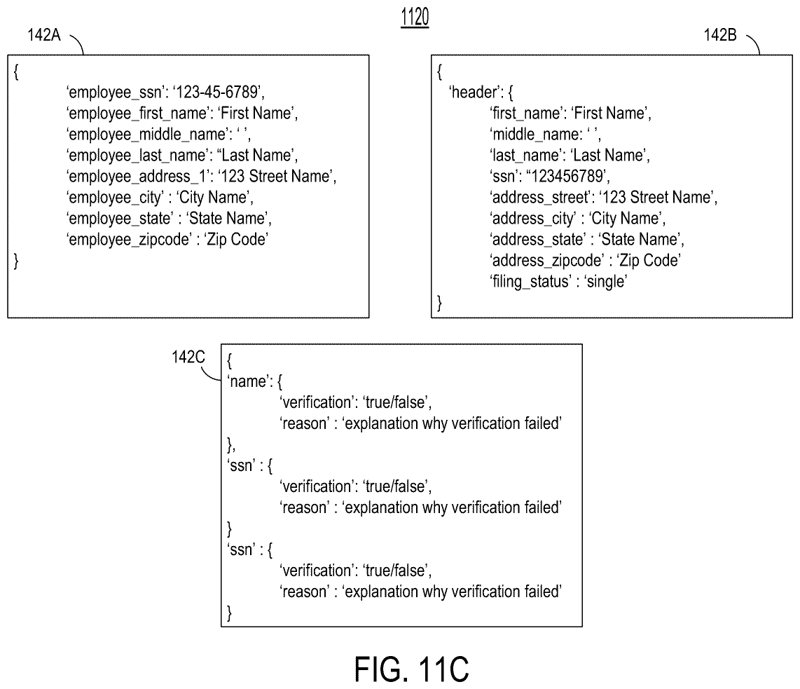

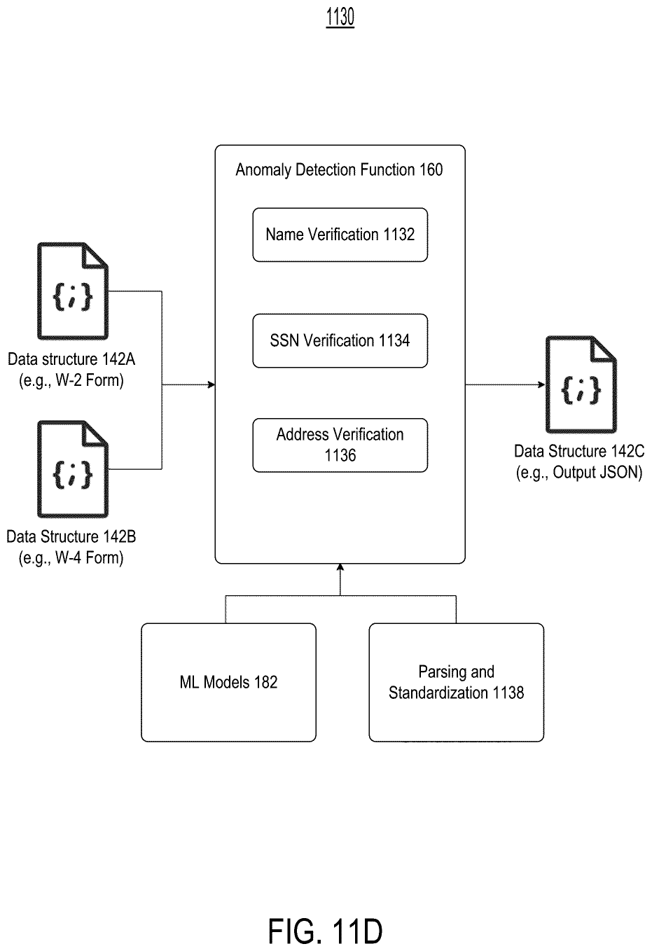

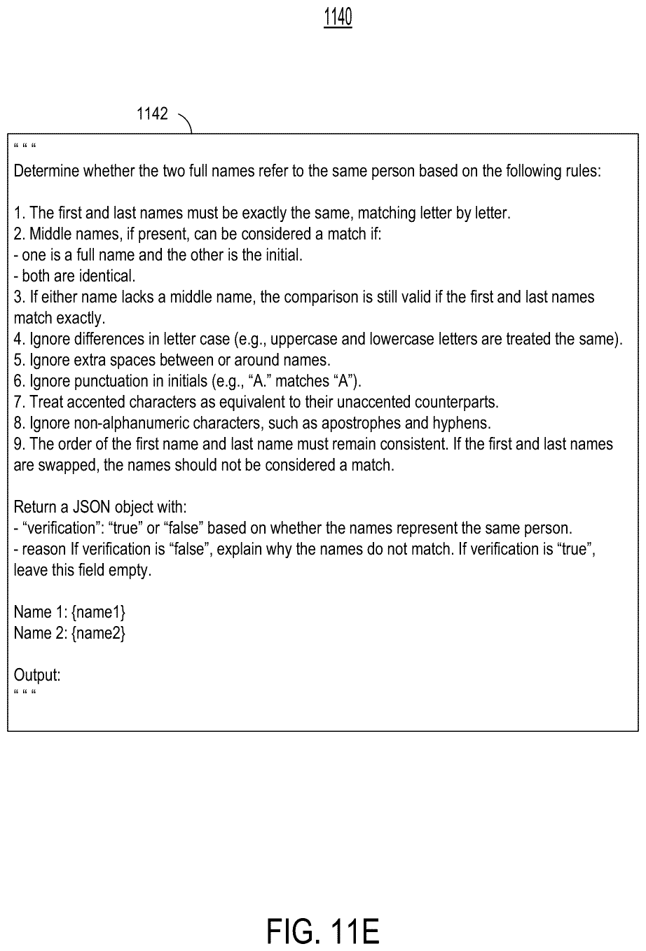

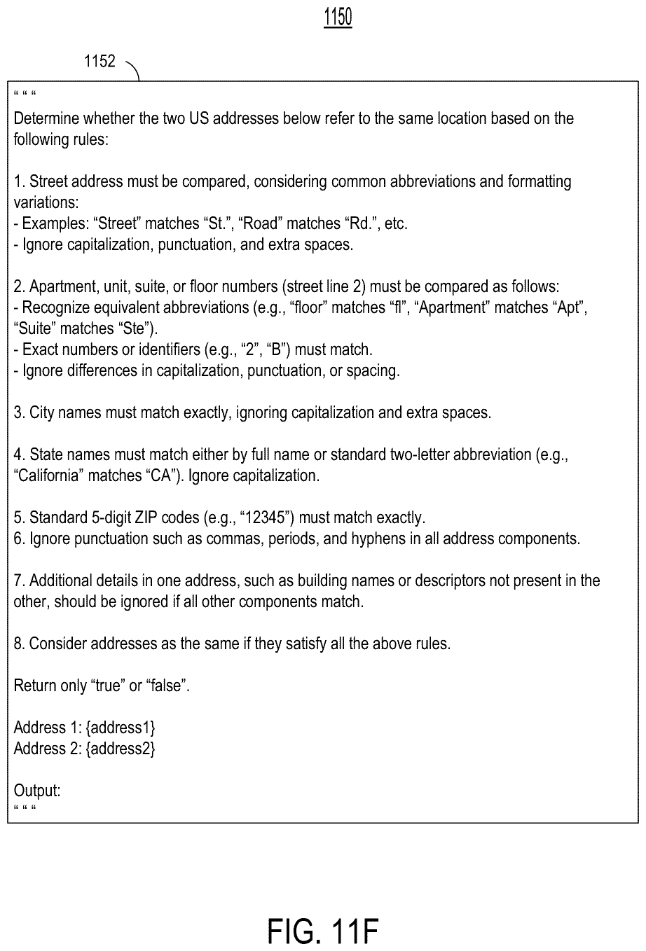

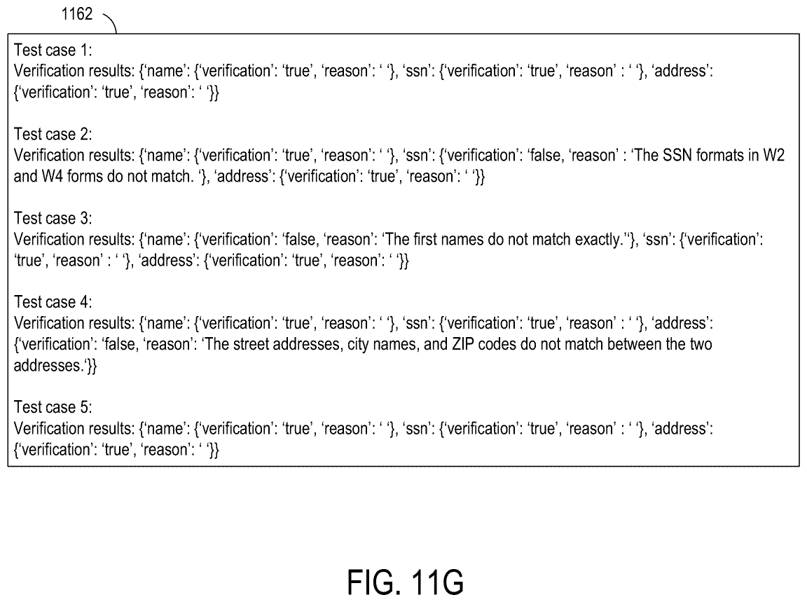

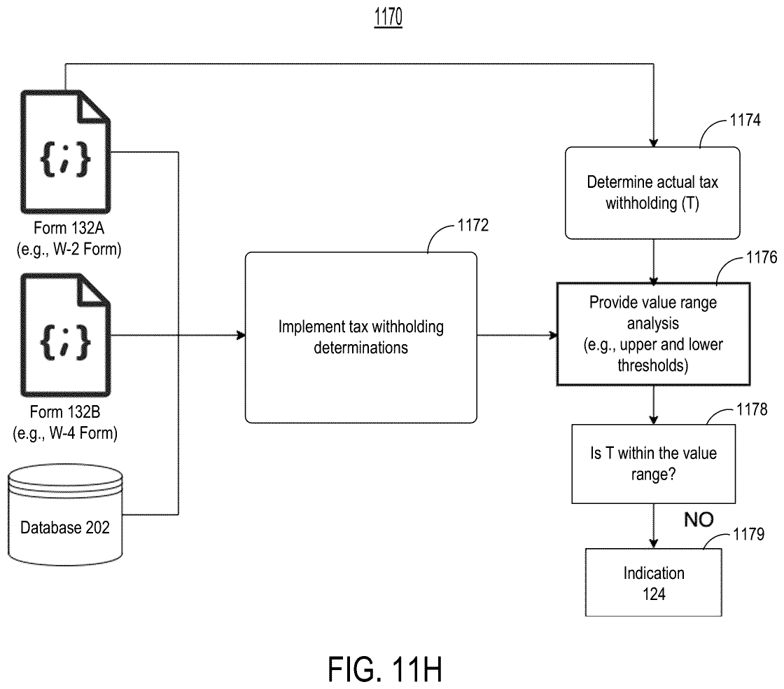

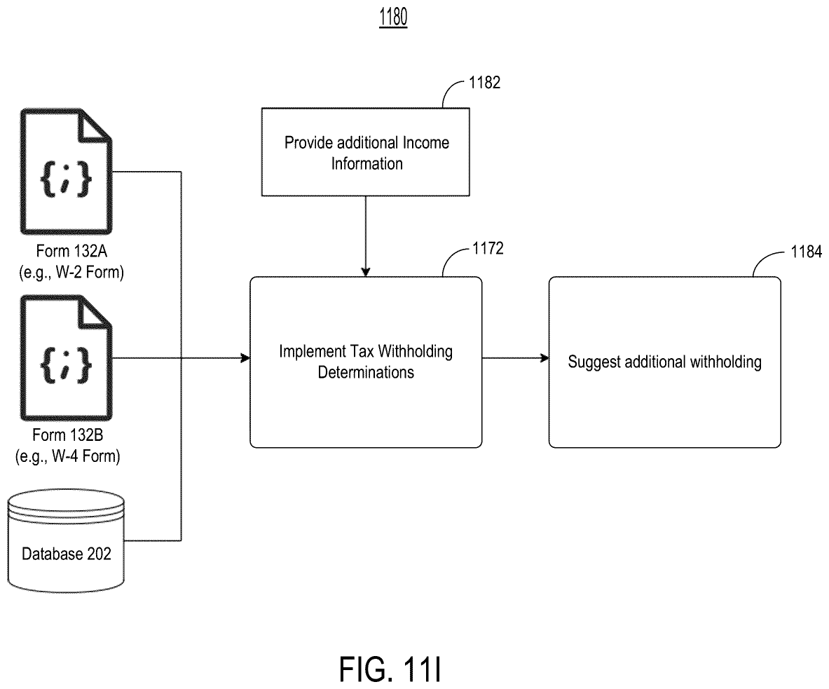

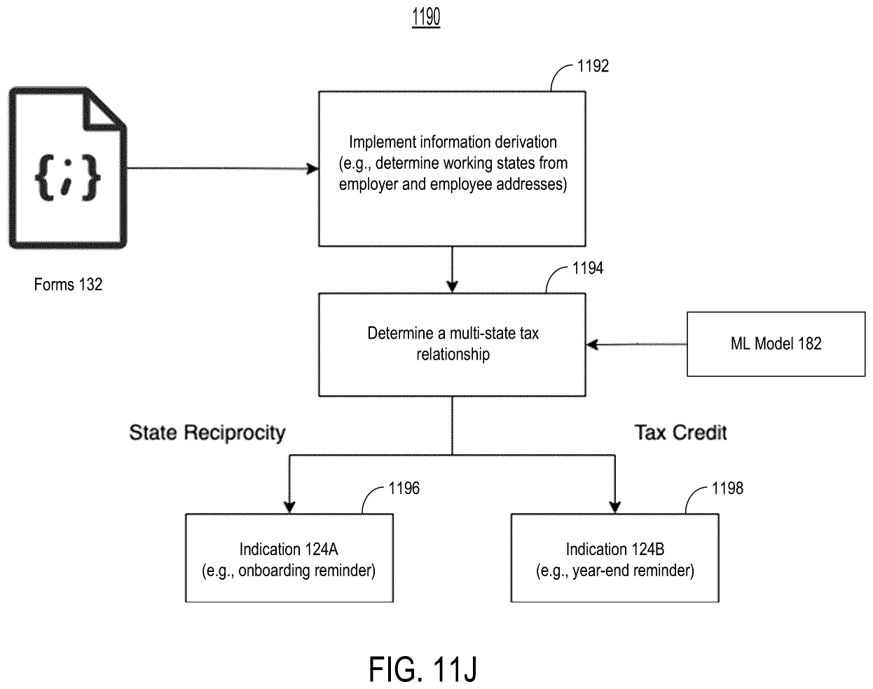

FIG. 11A illustrates an example system 1100 for training or retraining the ML models 182 of the technical solutions using chatbot functionalities that can be incorporated into and utilized by the data processing system 120. The example system 1100 can be combined with or used alongside any features of example systems 100 or 200, and vice versa. System 1100 can include a training data (e.g., tax data stored in a database) that can be used to fine tune or train an ML model 182 (e.g., LLM model). A chatbot interface 1102, can be an interface component of the Interface 122 or the graphical user interface 104 for utilizing ML models 182 to generate communications and responses to user queries on various anomalies or issues within the context of the questions The chat question/answer (Q/A) user interface (UI) 1102 can be used to send an application programming interface (API) call with the first question to the ML model (e.g., call API with Q1) which can be provided by the UI in response to a receive query (e.g., Q1) from the user. In response to the first question being received, the ML model can respond with a return answer (e.g., return answer to Q1). The return answer can include a text message or an API call to the chat Q/A UI. Then the chat Q/A UI 1102 can provide the answer to the user

For example, system 1100 can be trained with a dataset of training data 1104 that can include thousands of help and support articles (e.g., 5 k to 10 k documents), site contents (e.g., 800-5000 documents) and thousands of HR documents (e.g., 10 k-100 k). System 1100 can train ML models 182 using the training data 1104. The training data 1104 can include any data stored in a database 202. The training data 1104 can be utilized for prompt engineering. For example, prompt engineering for ML models 182 can include the construction of high-quality training data that can include prompt-completion pairs. For instance, an ML model 182 can utilize a JSON or JSONL file format, characterized by the structure: {“prompt”: “<prompt text>”, “completion”: “<ideal generated text>”}. Such an approach can improve the precision of fine-tuning efforts. For instance, an exemplar question, “How to add a new employee?”—can provide a corresponding prompt-completion pair is structured as follows: {“prompt”: “How to add a new employee?”, “completion”: “You have the option to onboard your employee or let themselves onboard through a user interface. Start here: People >Add new employee (W2) Select the way you want your employee to onboard . . . “} This format can allow for clear communication between the desired prompt and its intended completion in terms of AI model training.

The user selections or queries and the corresponding responses (e.g., completions or answers) can be communicated via the interfaces and GUIs. To convert the data into the desired format, the solutions can utilize different ways. For instance, the system can include collecting the possible questions from users search string history and the corresponding destination link/page the users clicked. User can use a generative AI model's APIs to create questions/answers based on the content (e.g. H&S article) with human reviews. The system can include any number of tokens, where a token can include approximately 0.75 words. For instance, 1000 tokens can correspond to about 750 words.

FIG. 11B illustrates an example of a flow diagram 1110 of operations implemented by an anomaly detection function 160 during the course of detecting anomalies 166. The example flow diagram 1110 can be a workflow implemented by the anomaly detection function 160 involving actions or operations 1106, 1112 and 1116 utilizing W-2 header section 1108, W-2 federal tax section 1114 and W-2 state tax section 1118 of the W-2 form 132. While example flow diagram 1110 shows operations or actions 1106-1118 implemented in an illustrated order, it is understood that these operations or actions can be implemented in any order, out of order, with some of the operations or actions not being implemented at all, while others being implemented multiple times.

At 1106, an anomaly detection function 160 can implement a personal information verification. At 1106, personal information verification can involve comparison of personal information (e.g., employee names and addresses) across various forms 132 to identify any anomalies 166 (e.g., errors, such as typos or format inconsistencies). To implement this operation the personal information verification 1106 can reach into the W-2 header section 1108 of the W-2 form 132 and access the relevant data (e.g., name and address entries 134). In the event that the personal information verification operation identifies some of the entries that do not match, the system can detect an anomaly 166 and take corrective action 172.

At 1112, the anomaly detection function 160 can implement a tax withholding suggestions operation. At 1112, tax withholding suggestions can involve computation of tax withholdings from the pay periods (e.g., weekly or monthly) of entity account 138. To implement these determinations, the tax withholding suggestions can determine amount of income, identify the relevant tax bracket of the entity account, determine a predicted amount of tax withholding for the year, and based on the number of pay periods remaining, including a ratio between the already implemented pay periods and the remaining pay periods of the year, determine a suggested tax withholding for the upcoming pay period. To implement this operation the tax withholding suggestions can reach into the W-2 state tax section 1118 of the W-2 form 132 and access the relevant data. In the event that the current withholding amounts fall outside of a value range for withholding parameter 162, the anomaly detection function 160 can detect an anomaly 166 and take corrective action 172.

At 1116, the anomaly detection function 160 can implement a tax credit and state reciprocity operation. At 1116, tax credit and state reciprocity operation can involve determining whether tax credit and state reciprocity is available for a client account. To implement these determinations, the tax credit and state reciprocity operation can determine locations of residence and work (e.g., addresses) associated with the entity account 138 and determine if the account can utilize the tax credit and state reciprocity. To implement this operation the tax credit and state reciprocity operation can reach into the W-2 federal tax section 1114 of the W-2 form 132 and access the relevant data. In the event that the data associated with the entity account 138 satisfies the rules for the tax credit and state reciprocity operation and such settings are not yet applied to the entity account 138, the anomaly detection function 160 can detect an anomaly 166 and take corrective action 172.

FIG. 11C illustrates examples configuration 1120 of input and output data structures 142 that can be used for implementing anomaly detection involving personal information verification. The example configuration 1120 can involve a JSON object data structure 142A representing personal information (e.g., name and address) of an employee of an entity account 138 and a JSON object data structure 142B representing personal information (e.g., name and address) of the same employee of the same entity account 138. The example configuration 1120 can also involve or correspond to a JSON object data structure 142C representing the output of the comparison or matching of the data of the data structures 142A and 142B.

In particular, the data structure 142A of a W-2 form 132 can list or include confidential information of the entity account 138 of an employee, including the employee's first and last names, social security number (SSN), and address including the street, city, state and ZIP code information. The data structure 142B of a W-4 form 132 can list or include the same type of personal information as is listed in the W-2 form 132, and as shown further in FIG. 11D, these two data structures can have their data compared to identify or detect any anomalies 166 which can be reflected in the output data structure 142C representing the results of the anomaly analysis by comparing the data structures of the two forms (e.g., for W-2 and W-4). The resulting output data structure 142C can state whether each individual compared information information match or do not match, thereby detecting an anomaly 166 when a non-matching information is identified in a particular parameter 162 of a form 132. Data structure 142C (e.g., verification output) can utilize the same JSON object data structure format as the data structure 142A (e.g., W-2 form data) and 142 (e.g., W-4 form data).

FIG. 11D illustrates an example configuration 1130 of an operation or action performed by an anomaly detection function 160. The configuration 1130 of the anomaly detection function implementation can utilize the same input data structures 142A and 142B as presented in FIG. 11C to produce an output data structure 142C. Data structures 142A and 142B can be input into the anomaly detection function 160. The anomaly detection function 160 can utilize several network operations 112 of a network operations system 110 to check for anomalies 166. The anomaly detection function 160 can utilize one or more ML models 182 and parsing and standardization 1138 function to parse and standardize information while performing any operations or actions 1132, 1134 or 1136.

The anomaly detection function 160 can utilize an ML model 182 and execute a network operation 112 to implement a name verification 1132. The name verification 1132 operation can be a type of a network operation 112 to check correct or accurate input of the name associated with the entity account 138 (e.g., name of the employee of the account) across a plurality of forms 132 or entries (e.g., W-2 form 132 and W-4 form 132). The name verification 1132 operation can identify any mismatch between first name entries 134 or last name entries 134 in different forms 132 and the anomaly detection function 160 can, in response to such mismatch, determine that this mismatch is an anomaly 166.

The anomaly detection function 160 can utilize an ML model 182 and execute a network operation 112 to implement a social security number (SSN) verification 1134. The SSN verification 1134 operation can be a type of a network operation 112 to check correct or accurate input of the SSN entry 134 associated with the entity account 138 across a plurality of forms 132 or entries (e.g., W-2 form 132 and W-4 form 132). The SSN verification 1134 operation can identify any mismatch between SSN entry 134 in a first form and SSN entry 134 in a second form and the anomaly detection function 160 can, in response to such mismatch, determine that this mismatch is an anomaly 166.

The anomaly detection function 160 can utilize an ML model 182, a parsing and standardization 1138 function to implement an address verification 1136. The SSN verification 1134 operation can be a type of a network operation 112 to check correct or accurate input of the address entry 134 associated with the entity account 138 across a plurality of forms 132 or entries (e.g., W-2 form 132 and W-4 form 132). The address verification 1136 operation can identify any mismatch between an address entry 134 in a first form and an address entry 134 in a second form and the anomaly detection function 160 can, in response to such mismatch, determine that this mismatch is an anomaly 166.

Referring now to FIGS. 11E-G, examples shown in FIG. 11E and FIG. 11F provide examples of prompts 1142 and 1152 that can be utilized as inputs to ML models 182 to prompt or direct the ML models 182 (e.g., generative AI models) to implement information data matching and comparison and provide test case results 1162. In example 1140 of FIG. 11E, the prompt template 1142 can provide instructions or data for a generative AI model to compare name information across different forms 132 to detect anomalies 166. In example 1150 of FIG. 11F, the prompt template 1154 can provide instructions or data for a generative AI model to compare address information across different forms 132 to detect anomalies 166. In example 1160 of FIG. 11G, test case results 1162 can provide results of individual tests cases, indicating whether mismatched information is found and providing reasoning or additional information for the mismatch found.

FIG. 11H illustrates an example flow diagram of method 1170 for identifying anomalies involving tax withholding amounts. The method 1170 can include operations 1172-1179. The method 1170 can be implemented using information from a form 132A (e.g., W-2 form), a form 132B (e.g., W-4 form), along with any other data from a database 202, which can be used as inputs into a tax withholding determination operation 1172. The operation 1172 can be an operation implemented by the anomaly detection function 160. Based on a form 132A (e.g., W-2 form), at operation 1174 an actual tax withholding amount (T) can be determined or computed. The tax withholding amount (T) can be an amount of tax withholding for pay periods in the current year determined up to a current point of the fiscal year. Using the tax withholding determinations from operation 1172, which can utilize ML models 182 to implement various anomaly detection function 160 functionalities, a determination can be made from a form 132B of a projected amount of tax withholding for the year.

At operation 1176, a value range analysis can be provided. For instance, the output from the tax withholding suggestions at 1172 and actual tax withholding at 1174 can be combined to determine if the projected (e.g., combined actual tax withholding paid thus far from form 132A and projected additional tax withholding projected from form 132B) is within the value range 164 for the annual tax withholding. The value range analysis 1176 can have an upper and a lower threshold or bound to determine if the projected tax withholding amount for the year for the entity account 138 falls within or outside of that value range 164.

At operation 1178, the anomaly detection function 160 can determine if the actual tax withholding amount (T) is within or outside of the value range 164 for the annual tax withholding. This determination can be made responsive to projecting or determining the expected annual income for the entity account 138 and determining the actual currently paid tax withholding amount and the projected tax withholding amount to be paid for the remaining number of pay periods for the remainder of the year. At operation 1178, the anomaly detection function 160 can determine that the projected tax withholding amount is within or outside of the value range. If the actual tax withholding being made through the pay periods is not sufficient (e.g., falls outside of the value range), an anomaly 166 can be detected.

At operation 1179, in response to the anomaly detected, the interface 122 can generate an indication 124 (e.g., to the GUI 104) to indicate a detection of the anomaly 166. The indication 124 can state that the current amount of tax withholding is insufficient and propose a corrective action 174 to increase the tax withholding. The indication 124 can include a timer 152 providing a time interval at the expiration of which a corrective action 174 is to be executed.

Still referring to FIG. 11H, the example implementation 1170 can relate to systems and method for detecting anomalies in amount of withheld taxes in network operations involving pay period wage transactions. The anomaly detection function can be implemented using one or more processors that can be configured (e.g., via instructions, code and data stored in memories coupled with the one or more processors) to perform various operations.

For instance, the one or more processors can be configured to identify one or more payroll amounts associated with a first payroll operation for a first form of an entity account. Each of the one or more payroll amounts can be determined periodically over a first portion of a time interval (e.g., a taxable time period of a year) comprising the first portion (e.g., a portion of the tax year for which the entity account is already compensated or paid) and a second portion subsequent to the first portion. The second portion of the time interval correspond to the remaining portion of the tax year to be covered by future pay periods.

The one or more processors can be configured to identify one or more withholding amounts associated with the first form. The one or more withholding amounts can be associated with the one or more payroll amounts. The one or more processors can be configured to determine, based on a sum of the one or more payroll amounts and a ratio between the first portion and the time interval, a range of withholding for the time interval. The one or more processors can be configured to identify a second one or more amounts associated with a second payroll operation of a second form for the first portion of the time interval and a second one or more withholding amounts associated with each of the second one or more amounts.

The one or more processors can be configured to generate, based at least on the second one or more amounts and the second one or more withholding amounts input into one or more machine learning models trained to predict withholding amounts for the time interval for a plurality of entity accounts, a predicted withholding amount the second portion of the time interval. The one or more processors can be configured to determine, based on the predicted withholding amount and the range of withholding, a setting for determining remaining second one or more withholding amounts to be withheld from remaining second one or more amounts during the second portion of the time interval. The one or more processors can be configured to implement the new setting in one or more network operations to perform adjusted determination of tax withholding to future payments across future pay periods. The one or more processors can be configured to generate, for display based on the determination, an indication of the new setting.

FIG. 11I illustrates an example flow diagram of a method 1180 for identifying anomalies involving tax withholding amounts when an additional source of income is involved. The method 1180 can be implemented using information from a form 132A (e.g., W-2 form), a form 132B (e.g., W-4 form), along with any other data from a database 202, which can be used as inputs into a tax withholding determination 1172 operation.

At 1182, another input into the tax withholding suggestions 1172 can be provided from a form 132 having additional income information. The additional income information can include information from a second job (e.g., W-2 or W-4 from a second or a third job of an entity account 138). In response to identifying a second set of tax forms, the system can determine that the entity account 138 is related or connected to another entity account 138 (e.g., the same person can be employee of two enterprises). The additional income information 1182 can include a one-time payment information from a form of a one-time project or a plurality of periodic payments.

At 1172, the method can implement tax withholding determinations, such as those implemented or described in connection with FIG. 11H. Tax withholding determinations can utilize the ML model 182 to determine prospective or predicted tax withholding for a plurality of pay periods. At 1184, the method can include suggesting additional withholding. For instance, in response to utilizing ML model 182 at the 1172 operation, a determination can be made that an anomaly 166 exists with respect to the amount of tax withheld for each pay period.

At 1184, in response to the determination at 1172, the method can issue an indication 124 or a GUI element 106 indicating that additional tax withholding is recommended. The GUI element 106 can include a timer 152 that can trigger execution of the action 172 to make an adjustment 174 to the parameter 162 associated with this tax withholding amount, such as establish a new or updated tax withholding amount or percentage to be used for upcoming pay period.

FIG. 11J illustrates an example flow diagram of a method 1190 for identifying anomalies involving multi-state tax relationships. The method 1190 can be implemented using operations 1192-1198. The method 1190 can utilize information from various forms 132 (e.g., W-2 or W-4) associated with one or more entity accounts 138, which can include information indicating residential address of an employee in a first state and an employer address at a location in a second state. The anomaly detection function 160 can determine that the two states listed in the addresses of the entity account have an agreement allowing for certain adjustments to the employee with respect to the state taxes, such as state reciprocity or tax credits to the employe, triggering detection of an anomaly 166.

At 1192, the method can implement information derivation from various forms 132. The information derivation can include data structures 142 being utilized to compare addresses at which an employee resides with addresses at which the employee works. At 1194, the method can use the residential and workplace addresses associated with the entity account 138 to determine or evaluate whether a multi-state relationship exists between the two states in the addresses. The method can utilize ML model 182 to determine the presence and nature of any agreement, identifying if the entity account 138 is eligible for certain exceptions, such as state reciprocity or tax credit exceptions. The state reciprocity exception can be an exception where employee is taxed as an employee of a home state at which the employee resides. The tax credit exception can involve a tax credit to the employee based on the addresses of employee's work and residence.

At 1196, in response to determining that the entity account 138 is eligible for a state reciprocity exception, the data processing system can generate an indication 124A to provide an onboarding reminder to onboard the new employee according to the state reciprocity. At 1198, in response to determining that the entity account 138 is eligible for a tax credit, the data processing system can generate an indication 124B to indicate that at the end of the year a tax credit is to be issued to the employee.

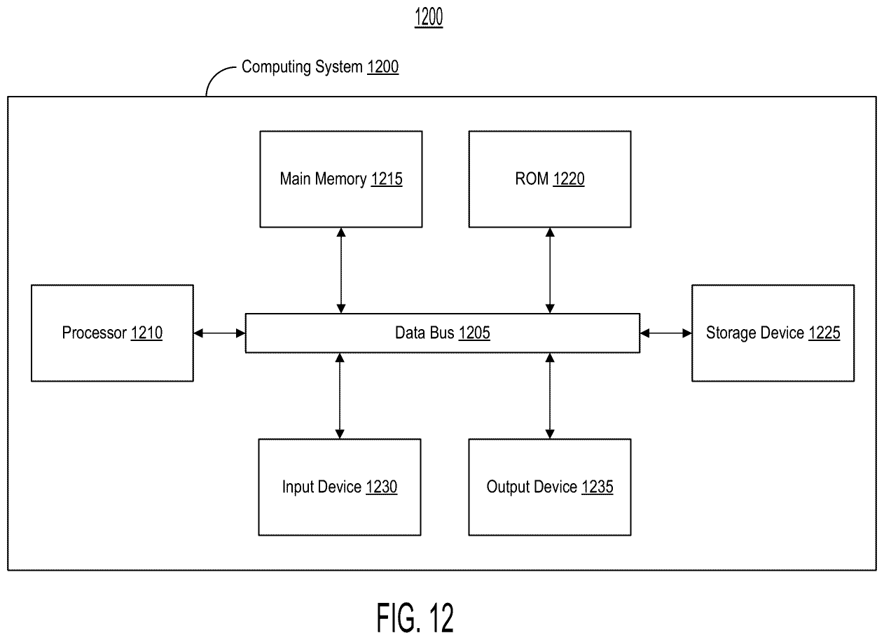

FIG. 12 illustrates a block diagram of a computing system for implementing the embodiments of the technical solutions, in accordance with embodiments. FIG. 12 illustrates a block diagram of an example computing system 1200, which can also be referred to as the computer system 1200. Computing system 1200 can be used to implement elements of the systems and methods described and illustrated herein, such as for example, commands, instructions or data described herein. Computing system 1200 can be included in and run any system or device, such as a system 100 of FIG. 1, system 200 of FIG. 2 or system 1100 of FIG. 11. The computing system 1200 can be utilized to provide a data processing system 120 an ML model 182, a client device 102, a network operations system 110, or any other component of any system or feature herein.

Computing system 1200 can include at least one bus data bus 1205 or other communication device, structure or component for communicating information or data. Computing system 1200 can include at least one processor 1210 or processing circuit coupled to the data bus 1205 for executing instructions or processing data or information. Computing system 1200 can include one or more processors 1210 or processing circuits coupled to the data bus 1205 for exchanging or processing data or information along with other computing systems 1200. Computing system 1200 can include one or more main memories 1215, such as a random access memory (RAM), dynamic RAM (DRAM), cache memory or other dynamic storage device, which can be coupled to the data bus 1205 for storing information, data and instructions to be executed by the processor(s) 1210. Main memory 1215 can be used for storing information (e.g., data, computer code, commands or instructions) during execution of instructions by the processor(s) 1210.

Computing system 1200 can include one or more read only memories (ROMs) 1220 or other static storage device 1225 coupled to the bus 1205 for storing static information and instructions for the processor(s) 1210. Storage devices 1225 can include any storage device, such as a solid state device, magnetic disk or optical disk, which can be coupled to the data bus 1205 to persistently store information and instructions.

Computing system 1200 may be coupled via the data bus 1205 to one or more output devices 1235, such as speakers or displays (e.g., liquid crystal display or active matrix display) for displaying or providing information to a user. Input devices 1230, such as keyboards, touch screens or voice interfaces, can be coupled to the data bus 1205 for communicating information and commands to the processor(s) 1210. Input device 1230 can include, for example, a touch screen display (e.g., output device 1235). Input device 1230 can include a cursor control, such as a mouse, a trackball, or cursor direction keys, for communicating direction information and command selections to the processor(s) 1210 for controlling cursor movement on a display.

The processes, systems and methods described herein can be implemented by the computing system 1200 in response to the processor 1210 executing an arrangement of instructions contained in main memory 1215. Such instructions can be read into main memory 1215 from another computer-readable medium, such as the storage device 1225. Execution of the arrangement of instructions contained in main memory 1215 causes the computing system 1200 to perform the illustrative processes described herein. One or more processors 1210 in a multi-processing arrangement may also be employed to execute the instructions contained in main memory 1215. Hard-wired circuitry can be used in place of or in combination with software instructions together with the systems and methods described herein. Systems and methods described herein are not limited to any specific combination of hardware circuitry and software.

Although an example computing system has been described in FIG. 12, the subject matter including the operations described in this specification can be implemented in other types of digital electronic circuitry, or in computer software, firmware, or hardware, including the structures disclosed in this specification and their structural equivalents, or in combinations of one or more of them.

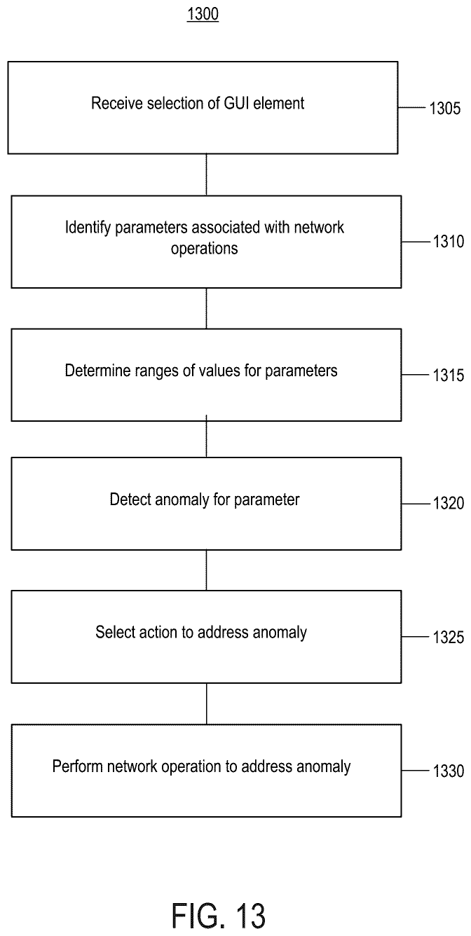

FIG. 13 shows a flow diagram of a method for providing a machine learning based form analysis and error detection, including a GUI triggered anomaly detection and correction of form data. Method 1300 can be implemented using the system tools, devices, features, actions and components discussed in FIGS. 1-12. The method 1300 can be implemented using one or more computing environments 1200 providing processors 1210 that can be configured using instructions, computer code and data stored in memories 1215, 1220 or 1225 to configure or cause the processors 1210 to perform acts or operations of the method 1300.

Method 1300 can include acts or operations 1305-1330. At act 1305, the method can receive a selection of a GUI element. At act 1310, the method can identify parameters associated with network operations. At act 1315, the method can determine ranges of values for the parameters. At act 1320, the method can detect an anomaly for a parameter. At act 1325, the method can select an action to address the anomaly. At act 1330, the method can perform network operations to address the anomaly.

At act 1305, the method can receive a selection of a GUI element. The method can include one or more processors coupled with memory receiving, via a graphical user interface (GUI) of a device, a selection of an element of the GUI to view data of a plurality of entity accounts generated using network operations. A data processing system can receive the selection of the GUI element provided to a GUI of a client device. The selection of the GUI element can indicate a user request to view or preview data corresponding to a plurality of different entity accounts corresponding to a plurality of employees of one or more enterprises. The data of the entity accounts can include various parameters corresponding to various values of entries of forms implemented or executed using network operations of a network operations system.

The method can include the one or more processors providing, for display via the GUI of the device, the GUI element providing access to a graphical representation of the data of the plurality of entity accounts. The method can include receiving, from the device, the selection of the GUI element in response to a user interaction with the element via the GUI at the client device. The method can include providing, for display via the GUI responsive to the selection, the graphical representation of the data. The graphical representation of the data can include visual representations of a plurality of parameters for a plurality of accounts. The graphical representation can provide a window or an interface for viewing anomalies identified by the anomaly detection function.

At act 1310, the method can identify parameters associated with network operations. The method can include the one or more processors identifying, responsive to execution of an anomaly detection function, from the data of the plurality of entity accounts, a plurality of parameters associated with execution of a plurality of network operations. The method can include executing an anomaly detection function responsive to the selection and prior to performance of actions responsive to the selection in order to identify, upon the execution of the anomaly detection function, from the data of the plurality of entity accounts, a plurality of parameters associated with execution of a plurality of network operations. The GUI of the client device can receive the data corresponding to the plurality of entity accounts and display the received data for preview by the user of the client device. The anomaly detection function can identify various parameters being analyzed and can provide visual representations via GUI elements provided to the GUI of the client device. The GUI elements can represent various entity accounts or their respective data (e.g., parameters associated with various forms.

The identified parameters can be organized or structured into data structures corresponding to various entity accounts or particular parameters being monitored. The method can include a data structure generator utilizing an ML model trained to generate a data structure in a JSON format to generate a JSON object that includes or references entries of the form. The data structure generator can generate values indicating the characteristics or properties (e.g., values or amounts of parameters) indicated by the entries of the form at the JSON object. For example, the data structure generator can create a JSON object that includes entries for employee name, address, and social security number. The data structure generator can generate values for entries such as total annual income, federal tax withheld, and state tax withheld. The data structure generator can include entries for dependent care benefits, retirement plan contributions, and additional Medicare tax.

The data structure can be configured as a JavaScript object notation (JSON) object for input into the one or more ML models. Other than the JSON object, the data structure can be configured as an XML object, a YAML object, a BSON object, a MessagePack object, a Protobuf object, an Avro object, a Thrift object, a CSV object, a Parquet object, or an ORC object. The method can include the data structure generator generating the data structure that indicates a plurality of values for the plurality of entries, based on the form.

At act 1315, the method can determine ranges of values for the parameters. The method can include the one or more processors determining, based on the data, a plurality of ranges of values for the plurality of parameters. Each range of values of the plurality of ranges can correspond to a respective parameter of the plurality of parameters. The anomaly detection manager can determine, based on historical data of the plurality of entity accounts, a threshold value for the range of values for the parameter. The method can generate the ranges of values of the parameter based on the threshold value. The method can include the anomaly detection function determining, based on the data identified upon the execution of the anomaly detection function, a plurality of ranges of values for the plurality of parameters. Each range of values of the plurality of ranges can correspond to, or be created for, a respective parameter of the plurality of parameters.

For instance, the anomaly detection function can determine the value range for the particular parameter based on the lower and upper boundaries (e.g., thresholds) for that parameter. The value range thresholds or bounds can be determined based on the historical data of the parameter type to which the parameter belongs. For instance, threshold values for tax withholding amounts can be determined based on historical tax withholding data for the parameters of entity accounts within the same tax bracket range. In some implementations, the anomaly detection function determines the value range based on other entries of the same parameter. For example, a value range for a parameter indicating a name of an account holder (e.g., name of employee) can be determined based on other entries of the same name of the same account holder. In such instances, the value range corresponds to either the exact same full name of the account holder (e.g., name on the entity account) or to the same full and last names without any middle name or middle initial, or with a middle initial matching the first letter of the middle name.

At act 1320, the method can detect an anomaly for a parameter. The method can include the one or more processors detecting an anomaly corresponding to a parameter of the plurality of parameters that is out of a range of values of the plurality of ranges of values corresponding to the parameter. The method can detect the anomaly corresponding to the parameter based on the plurality of parameters and the plurality of ranges of values input into one or more ML models. The one or more ML models can be trained using parameters and ranges of values for network operations of entity accounts. An ML model can compare each of the parameters with the value range for the given parameter and determine if the parameter falls within the value range (e.g., in the instance in which the parameter is a value within a range of values). In some instances, the ML moder can compare the parameter with the value range and determine if the parameter matches the value range (e.g., in the instances in which the parameter is a string of characters), such as a name or an address, to be compared with other string of characters (e.g., where the value range is the same string of characters in the same or a different format).

The anomaly detection function can determine the causes or reasons of the detected anomaly. For instance, the method can include detecting the anomaly or determining that the anomaly is responsive to a value of the parameter for an amount withheld from a first electronic transaction implemented via the network operation falling out of the range of values for the amount withheld. The method can include detecting the anomaly responsive to a mismatch between a first entry of a first form associated with an entity account and a second entry of a second form associated with the entity account. Each of the first entry and the second entry can match the parameter associated with the entity account. The method can detect the anomaly corresponding to the parameter of an entity account responsive to a plurality of forms from a plurality of states associated with the entity account.

The method can include identifying one or more amounts associated with the parameter for a first form of an entity account. The one or more amounts can be amounts of pay period salary or wage payments associated with the entity account. Each of the one or more amounts can be determined periodically over a first portion of a time interval, such as a tax year. The time interval can include a first portion (e.g., already implemented pay period operations during the first part of the year) and a second portion subsequent to the first portion (e.g., corresponding to a remainder of the tax year). The method can identify one or more withholding amounts associated with the first form, where the withholding amounts are with the one or more amounts (e.g., tax withholding amounts for each of the pay periods). The method can include determining, based on a sum of the one or more amounts and a ratio between the first portion and the time interval, the range of values for a sum of withholding amounts for the time interval.

The method can include identifying a second one or more amounts associated with a second operation of a second form for the first portion of the time interval and a second one or more withholding amounts associated with each of the second one or more amounts. The second one or more amounts can include a different pay periods or different wages for the same entity account from a different enterprise (e.g., a second job). These second amounts and their corresponding tax withholding amounts can cover the same first portion of the time interval (e.g., tax year).

The method can include generating, based at least on the second one or more amounts and the second one or more withholding amounts input into the one or more ML models, a predicted withholding amount of the parameter. The predicted withholding amount can be for the second portion of the time interval (e.g., upcoming pay periods within the remainder of the tax year). The predicted withholding amount can be out of the range of values for the sum of withholding amounts for the time interval. The method can include adjusting the predicted withholding amount to cause the predicted total tax withholding amount for the entire time interval to fall within the range of values.

At act 1325, the method can select an action to address the anomaly. The method can include the one or more processors selecting, responsive to the detection, an action to address the anomaly. The action can be any action, such as a generation of an adjustment (e.g., a new parameter value to replace the prior anomalous parameter). The action can include selecting one or more network operations to execute to compute an adjustment parameter. The adjustment parameter can include a corrected first or last name of a holder of the entity account matching other entries of the name, an adjusted wage amount that falls within an expected value range for the wage amount, an adjusted tax withholding amount that falls within the expected value range for the tax withholdings for the employee within the same tax bracket range.

The one or more processors can provide, for display on the GUI responsive to the detection, an indication of at least one of the anomaly corresponding to the parameter or the action to address the anomaly. The one or more processors can receive, via the GUI, a selection of a second element to initiate a manual review of the detected anomaly; and provide, for display on the GUI, an interface for an input of a result for the manual review.

At act 1330, the method can perform network operations to address the anomaly. The method can include the one or more processors performing, responsive to the selected action, a network operation of the plurality of network operations to address the anomaly. The method can include performing a network operation of the plurality of network operations to address the anomaly, responsive to the selected action and subsequent to the execution of the anomaly detection function. The network operation can be any network operation to generate an adjustment parameter (e.g., replacing the anomalous parameter) or performing operations using the adjusted or corrected parameter. The network operations can be performed or triggered using application programming interface (API) calls to automate network operation execution.

The method can include generating a timer to expire according to a predetermined time interval. The method can include providing, for display on the GUI responsive to the detection, an indication that the network operation associated with the selected action is to be performed unless a selection of a second element of the GUI to preclude the performance of the network operation is received prior to the expiration of the timer. The one or more processors can perform the network operation in response to the expiration of the timer (e.g., by issuing an API call in response to the timer elapsing in absence of any GUI selection requesting otherwise).

The method can include determining that the anomaly is responsive to a value of the parameter for an amount withheld from a first electronic transaction implemented via the network operation falling out of the range of values for the amount withheld. The method can include adjusting the value for the parameter according to the range of values for the amount withheld and performing or triggering the network operation for a second electronic transaction using the adjusted value for the parameter.

The method can include detecting the anomaly responsive to a mismatch between a first entry of a first form associated with an entity account and a second entry of a second form associated with the entity account. Each of the first entry and the second entry can match the parameter associated with the entity account. The method can include adjusting, responsive to the first entry and the second entry matching the parameter, the first entry to match the second entry. The method can include performing the network operation for a next electronic transaction using the adjusted first entry.

The method can include detecting the anomaly corresponding to the parameter of an entity account responsive to a plurality of forms from a plurality of states associated with the entity account. The method can include adjusting, responsive to the plurality of forms from the plurality of states associated with the entity account, a withholding amount for a next electronic transaction associated with the entity account. The method can include performing the network operation for the next electronic transaction using adjusted withholding amount.

The method can include receiving, via the GUI, a selection of a second element to generate a report summarizing one or more detected anomalies including the anomaly and corresponding one or more actions for the detected anomalies including the action. The method can include provide, for display on the GUI, the generated report. The method can include determining, based on the predicted withholding amount and the range of withholding, a setting for determining remaining second one or more withholding amounts to be withheld from remaining second one or more amounts during the second portion of the time interval.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer-based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C #, PROLOG, or in any byte code language such as JAVA. The software programs or executable instructions can be stored on or in one or more articles of manufacture as object code.

The subject matter and the operations described in this specification can be implemented in digital electronic circuitry, or in computer software, firmware, or hardware, including the structures described in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order. Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently described systems or methods, their components, acts, or elements to single or plural configurations. References to any act or element being based on any information, act or element may include implementations where the act or element is based at least in part on any information, act, or element.

Any implementation described herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations described herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as substitutions, changes and omissions can be made in the design, operating conditions and arrangement of the described elements and operations without departing from the scope of the technical solutions described herein.

References to “approximately,” “substantially”, or other terms of degree include variations of +/−10% from the given measurement, unit, or range unless explicitly indicated otherwise. Coupled elements can be electrically, mechanically, or physically coupled with one another directly or with intervening elements. Scope of the Systems and methods described herein is thus indicated by the appended claims, rather than the foregoing description, and changes that come within the meaning and range of equivalency of the claims are embraced therein.

What is claimed is:

1. A system, comprising:
one or more processors, coupled with memory, to:
receive, via a graphical user interface (GUI) of a device, a selection of an element of the GUI to view data of a plurality of entity accounts generated using network operations;
execute, responsive to the selection, and prior to performance of actions responsive to the selection, an anomaly detection function;
identify, based on the execution of the anomaly detection function, from the data of the plurality of entity accounts, a plurality of parameters associated with execution of a plurality of network operations;
determine, based on the data identified based on the execution of the anomaly detection function, a plurality of ranges of values for the plurality of parameters, each range of values of the plurality of ranges corresponding to a respective parameter of the plurality of parameters; and
detect, based on the plurality of parameters and the plurality of ranges of values input into one or more machine learning (ML) models, an anomaly corresponding to a parameter of the plurality of parameters that is out of a range of values of the plurality of ranges of values corresponding to the parameter, the one or more ML models are trained using parameters and ranges of values for network operations of entity accounts;
select, responsive to the detection, an action to address the anomaly; and
perform, responsive to the selected action, and subsequent to the execution of the anomaly detection function, a network operation of the plurality of network operations to address the anomaly.

2. The system of claim 1, wherein the one or more processors further:
generate a timer to expire according to a predetermined time interval; and
provide, for display on the GUI responsive to the detection, an indication that the network operation associated with the selected action is to be performed unless a selection of a second element of the GUI to preclude the performance of the network operation is received prior to the expiration of the timer.

3. The system of claim 2, wherein the one or more processors perform the network operation in response to the expiration of the timer.

4. The system of claim 1, wherein the one or more processors further:
provide, for display via the GUI of the device, the element providing access to a graphical representation of the data of the plurality of entity accounts;
receive, from the device, the selection of the element in response to an interaction with the element via the GUI; and
provide, for display via the GUI responsive to the selection, the graphical representation of the data.

5. The system of claim 1, wherein the one or more processors further provide, for display on the GUI responsive to the detection, an indication of at least one of the anomaly corresponding to the parameter or the action to address the anomaly.

6. The system of claim 1, wherein the one or more processors further:
determine that the anomaly is responsive to a value of the parameter for an amount withheld from a first electronic transaction implemented via the network operation falling out of the range of values for the amount withheld;
adjust the value for the parameter according to the range of values for the amount withheld; and
perform the network operation for a second electronic transaction using the adjusted value for the parameter.

7. The system of claim 1, wherein the one or more processors further:
detect the anomaly responsive to a mismatch between a first entry of a first form associated with an entity account and a second entry of a second form associated with the entity account, wherein each of the first entry and the second entry match the parameter associated with the entity account;
adjust, responsive to the first entry and the second entry matching the parameter, the first entry to match the second entry; and
perform the network operation for a next electronic transaction using the adjusted first entry.

8. The system of claim 1, wherein the one or more processors further:
detect the anomaly corresponding to the parameter of an entity account responsive to a plurality of forms from a plurality of states associated with the entity account;
adjust, responsive to the plurality of forms from the plurality of states associated with the entity account, a withholding amount for a next electronic transaction associated with the entity account; and
perform the network operation for the next electronic transaction using adjusted withholding amount.

9. The system of claim 1, wherein the one or more processors further:
receive, via the GUI, a selection of a second element to generate a report summarizing one or more detected anomalies including the anomaly and corresponding one or more actions for the detected anomalies including the action; and
provide, for display on the GUI, the generated report.

10. The system of claim 1, wherein the one or more processors further:
determine, based on historical data of the plurality of entity accounts, a threshold value for the range of values for the parameter; and
generate the ranges of values of the parameter based on the threshold value.

11. The system of claim 1, wherein the one or more processors further:
receive, via the GUI, a selection of a second element to initiate a manual review of the detected anomaly; and
provide, for display on the GUI, an interface for an input of a result for the manual review.

12. The system of claim 1, wherein the one or more processors further:
identify one or more amounts associated with the parameter for a first form of an entity account, each of the one or more amounts determined periodically over a first portion of a time interval comprising the first portion and a second portion subsequent to the first portion;
identify one or more withholding amounts associated with the first form, the one or more withholding amounts associated with the one or more amounts; and
determine, based on a sum of the one or more amounts and a ratio between the first portion and the time interval, the range of values for a sum of withholding amounts for the time interval.

13. The system of claim 12, wherein the one or more processors further:
identify a second one or more amounts associated with a second operation of a second form for the first portion of the time interval and a second one or more withholding amounts associated with each of the second one or more amounts; and
generate, based at least on the second one or more amounts and the second one or more withholding amounts input into the one or more ML models, a predicted withholding amount of the parameter for the second portion of the time interval that is out of the range of values for the sum of withholding amounts for the time interval.

14. A computer-implemented method, comprising:
receiving, by one or more processors coupled with memory, via a graphical user interface (GUI) of a device, a selection of an element of the GUI to view data of a plurality of entity accounts;
identifying, by the one or more processors responsive to execution of an anomaly detection function, from the data of the plurality of entity accounts, a plurality of parameters associated with execution of a plurality of network operations;
determining, by the one or more processors based on the data, a plurality of ranges of values for the plurality of parameters, each range of values of the plurality of ranges corresponding to a respective parameter of the plurality of parameters;
detecting, by the one or more processors based on the plurality of parameters and the plurality of ranges of values input into one or more machine learning (ML) models, an anomaly corresponding to a parameter of the plurality of parameters that is out of a range of values of the plurality of ranges of values corresponding to the parameter, the one or more ML models are trained using parameters and ranges of values for network operations of entity accounts;
selecting, by the one or more processors responsive to the detection, an action to address the anomaly; and
performing, by the one or more processors responsive to the selected action, a network operation of the plurality of network operations to address the anomaly.

15. The method of claim 14, comprising:
generating, by the one or more processors, a timer to expire according to a predetermined time interval;
providing, by the one or more processors for display on the GUI responsive to the detection, an indication that the network operation associated with the selected action is to be performed unless a selection of a second element of the GUI to preclude the performance of the network operation is received prior to the expiration of the timer; and
performing, by the one or more processors, the network operation in response to the expiration of the timer.

16. The method of claim 14, comprising:
providing, by the one or more processors for display via the GUI of the device, the element providing access to a graphical representation of the data of the plurality of entity accounts;
receiving, by the one or more processors from the device, the selection of the element in response to an interaction with the element via the GUI; and
providing, by the one or more processors for display via the GUI responsive to the selection, the graphical representation of the data.

17. The method of claim 14, comprising:
providing, by the one or more processors for display on the GUI responsive to the detection, an indication of at least one of the anomaly corresponding to the parameter or the action to address the anomaly.

18. The method of claim 14, comprising:
determining, by the one or more processors that the anomaly is responsive to a value of the parameter for an amount withheld from a first electronic transaction implemented via the network operation falling out of the range of values for the amount withheld;
adjusting, by the one or more processors, the value for the parameter according to the range of values for the amount withheld; and
performing, by the one or more processors, the network operation for a second electronic transaction using the adjusted value for the parameter.

19. The method of claim 14, comprising:
detecting, by the one or more processors, the anomaly responsive to a mismatch between a first entry of a first form associated with an entity account and a second entry of a second form associated with the entity account, wherein each of the first entry and the second entry match the parameter associated with the entity account;
adjusting, by the one or more processors, responsive to the first entry and the second entry matching the parameter, the first entry to match the second entry; and
performing, by the one or more processors, the network operation for a next electronic transaction using the adjusted first entry.

20. A non-transitory computer-readable medium comprising instructions that, when executed by one or more processors coupled with memory, cause the one or more processors to:
receive, via a graphical user interface (GUI) of a device, a selection of an element of the GUI to view data of a plurality of entity accounts generated using network operations;
execute, responsive to the selection, and prior to performance of actions responsive to the selection, an anomaly detection function;
identify, based on the execution of the anomaly detection function, from the data of the plurality of entity accounts, a plurality of parameters associated with execution of a plurality of network operations;
determine, based on the data identified based on the execution of the anomaly detection function, a plurality of ranges of values for the plurality of parameters, each range of values of the plurality of ranges corresponding to a respective parameter of the plurality of parameters; and
detect, based on the plurality of parameters and the plurality of ranges of values input into one or more machine learning (ML) models, an anomaly corresponding to a parameter of the plurality of parameters that is out of a range of values of the plurality of ranges of values corresponding to the parameter, the one or more ML models are trained using parameters and ranges of values for network operations of entity accounts;
select, responsive to the detection, an action to address the anomaly; and
perform, responsive to the selected action, and subsequent to the execution of the anomaly detection function, a network operation of the plurality of network operations to address the anomaly.
